(19) United States
(12) Patent Application Publication
(10) Pub. No.: US 2013/0113629 A1
(43) Pub. Date: May 9, 2013

(54) PHASE SENSITIVE COHERENT OTDR WITH MULTI-FREQUENCY INTERROGATION

(71) Applicant: Schlumberger Technology Corporation, Sugar Land, TX (US)

(72) Inventors: Arthur H. Hartog, Winchester (GB); Leonid Borisovich Liokumovich, St. Petersburg (RU)

(73) Assignee: SCHLUMBERGER TECHNOLOGY CORPORATION, Sugar Land, TX (US)

(21) Appl. No.: 13/656,499

(22) Filed: Oct. 19, 2012

Related U.S. Application Data
(60) Provisional application No. 61/555,894, filed on Nov. 4, 2011.
(60) Provisional application No. 61/588,926, filed on Jan. 20, 2012.

(51) Int. Cl. G01V 3/30

(52) U.S. Cl. 340/853.2

(57) ABSTRACT

A fiber optic sensor system includes a coherent-detection optical time domain reflectometry system to extract phase information from optical signals returned from a fiber optic sensor arrangement in response to a plurality of interrogating pulses. The system includes a frequency-shifting circuit to repeatedly translate the frequency of an optical pulse generated by a narrowband source to generate a train of interrogating pulses of multiple frequencies. The optical signals returned from the sensor arrangement in response to the pulse train is mixed on a photodetector with light from the narrowband source that has not been shifted to generate mixed output signals. The mixed output signals are filtered into frequency bands, and the phase for each frequency band is extracted.

This application claims the benefit of co-pending U.S. Provisional Application Ser. No. 61/555,894, entitled “Phase Sensitive Coherent OTDR With Multi-Frequency Interrogation,” filed on Nov. 4, 2011, and co-pending U.S. Provisional Application Ser. No. 61/588,926, entitled “Phase Sensitive Coherent OTDR With Multi-Frequency Interrogation,” filed on Jan. 20, 2012, both of which are incorporated herein by reference in their entireties.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir. One piece of equipment which may be installed is a sensing system, such as a fiber optic based sensing system to monitor various downhole parameters that provide information that may be useful in controlling and enhancing production.

### BRIEF DESCRIPTION OF THE DRAWINGS

Certain embodiments of the invention will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

FIG. 1 is a schematic illustration of an exemplary phase coherent-detection OTDR system, in accordance with an embodiment.

FIG. 2 is a schematic illustration of another exemplary phase coherent-detection OTDR system, in accordance with an embodiment.

FIG. 3 is a graph of an exemplary phase response of a strained optical fiber.

FIG. 4 illustrates modeling of differential phase measurements comparing the responses obtained from single interrogating frequencies with an average response of multiple interrogating frequencies.

FIG. 5A illustrates a heterodyne coherent Rayleigh backscatter signal returned from an optical fiber in response to a single laser pulse.

FIG. 5B shows a magnified portion of the signal of FIG. 5A.

FIG. 5C shows (as a function of time, measured in the number of elapsed laser pulses) the detected phase for a sequence of backscatter signals just before a sinusoidal disturbance at a point along the optical fiber tested in FIG. 5A, as well as the phase just beyond the region of disturbance, the phase difference, and the unwrapped phase difference.

FIG. 5D shows the spectrum derived from the data acquired from backscatter signals returned from the fiber tested in FIG. 5A in response to several thousand pulses, which includes the data of FIG. 5C.

FIG. 6 is a schematic illustration of an exemplary phase coherent-detection OTDR system deployed wellbore, in accordance with an embodiment.

FIG. 7 is a schematic illustration of an exemplary multi-frequency phase coherent-detection OTDR system, in accordance with an embodiment.

FIG. 8 is a schematic illustration of an exemplary frequency-shifting circuit to produce a train of interrogating pulses, in accordance with an embodiment.

FIG. 9 shows an exemplary pulse train output by a frequency-shifting circuit, in accordance with an embodiment.

FIG. 10 shows exemplary interrogating pulses and heterodyne backscatter signals generated in response to the pulses, in accordance with an embodiment.

FIG. 11 shows another example of heterodyne backscatter signals received from a sensing fiber in response to interrogating pulses, in accordance with an embodiment.

FIG. 12 shows a spectral analysis of the backscatter trace of FIG. 11.

FIG. 13 is a schematic illustration of another exemplary multi-frequency phase coherent-detection OTDR system, in accordance with an embodiment.

FIG. 14 is a schematic illustration of another exemplary frequency-shifting circuit to produce a train of interrogating pulses, in accordance with an embodiment.

FIG. 15 is a schematic illustration of another exemplary frequency-shifting circuit to produce a train of interrogating pulses, in accordance with an embodiment.

FIG. 16 is a schematic illustration of another exemplary frequency-shifting circuit to produce a train of interrogating pulses, in accordance with an embodiment.

FIG. 17 shows exemplary transmissions of each AOM in an exemplary multi-frequency phase coherent-detection OTDR system as a function of time for an example interrogating pulse train, in accordance with an embodiment.

FIG. 18 is a schematic illustration of another exemplary multi-frequency phase coherent-detection OTDR system, in accordance with an embodiment.

FIG. 19 is a schematic illustration of an exemplary filter for a frequency-shifting circuit, in accordance with an embodiment.

FIG. 20 is a schematic illustration of another exemplary multi-frequency phase coherent-detection OTDR system, in accordance with an embodiment.

FIG. 21 is a schematic illustration of another exemplary multi-frequency phase coherent-detection OTDR system, in accordance with an embodiment.

FIG. 22 is a schematic illustration of another exemplary frequency-shifting circuit to produce a train of interrogating pulses, in accordance with an embodiment.

FIG. 23 is a schematic illustration of another exemplary multi-frequency phase coherent-detection OTDR system, in accordance with an embodiment.

FIG. 24 shows an exemplary frequency pattern of a pulse to be used to generate interrogation pulses in the system of FIG. 23, in accordance with an embodiment.

FIG. 25 is a schematic illustration of another exemplary multi-frequency phase coherent-detection OTDR system, in accordance with an embodiment.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the disclosure. As used herein: the abbreviation “FCV” is understood to mean “flow control valve”; the abbreviation “POOH” is understood to mean “pulled out of the hole”; and “ICD” is understood to mean “inflow/outflow control device”.

Various embodiments of the disclosure comprise methods and apparatus that combine the use of coherent detection and phase-sensitive measurements in an optical time-domain reflectometry (OTDR) system to detect, classify and/or provide a measurement of time-dependent changes in a parameter, such as strain, along the length of a sensing fiber. Examples of fiber optic sensing systems that combine coherent-detection OTDR with phase measurements are disclosed in U.S. Publication No. 2012/0067118A1, entitled “Distributed Fiber Optic Sensor System With Improved Linearity,” the disclosure of which is incorporated by reference herein in its entirety.

OTDR generally is performed with a relatively broadband source. However, when OTDR measurements are carried out with a narrowband source (such that its coherence length is on the order of a pulse duration or, prior to modulation, much longer than a pulse width), then the phase of the backscattered signal from each given region (e.g., a resolution cell) of the sensing fiber is correlated with the phase of the backscatter from the other parts. The phase of the scattered signal from a given region is a result of the summation of the electric field phasor of each scatterer of the optical fiber. The phase is stable provided the frequency of the optical source is stable and the fiber is not disturbed in that region. Therefore if, between the two regions of undisturbed fiber, the fiber is strained, the phase-difference between these two regions will respond linearly to the applied strain. To measure this phase-difference, a coherent-detection OTDR system can be employed to extract phase information from the backscatter signal. The coherent-detection OTDR system can be configured as a heterodyne system, a homodyne system, or any of a variety of OTDR systems that are configured for coherent detection.

In such coherent-detection OTDR systems, the interrogating pulses launched into the sensing fiber may be at a single frequency. However, when multiple interrogation frequencies are used, the linearity of the measurement system and fading of the returned signal can be improved relative to a single-frequency coherent-detection OTDR system. Various embodiments configured to interrogate a sensing fiber or a sensor array with pulses of multiple frequencies are described herein.

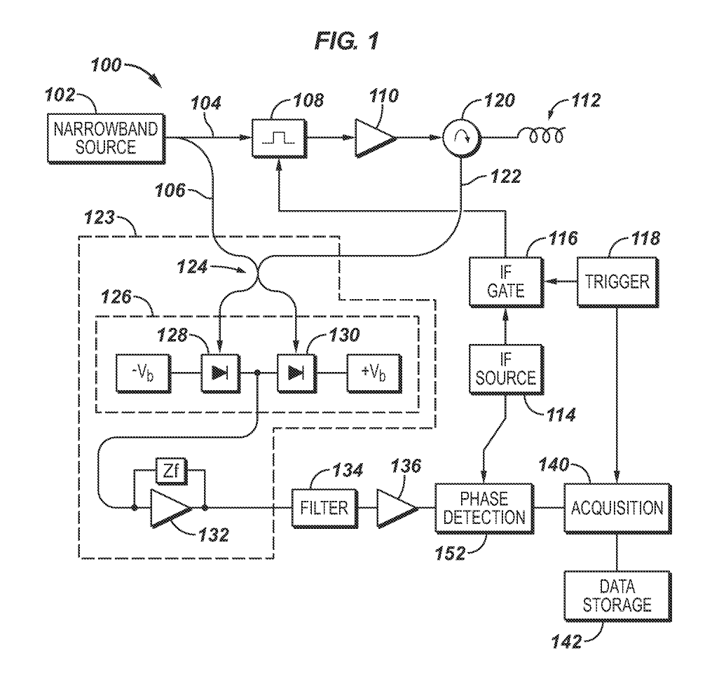

Turning now to FIG. 1, a known exemplary arrangement for a phase-measuring coherent-detection OTDR system 100 is illustrated which employs heterodyne coherent detection. The system 100 includes an optical source 102, which can be a narrowband source such as a distributed feedback fiber laser (which generally provides the narrowest available spectrum of lasers for which the emission wavelength can be selected over a wide range). The output of the source 102 is divided into a local oscillator path 106 and another path 104. In path 104, a modulator 108 modulates the optical signal into a probe pulse, which additionally many be amplified by amplifier 110 prior to being launched into a sensing fiber 112. For the heterodyne system illustrated in FIG. 1, the probe pulse and the local oscillator signal are at different carrier frequencies. A frequency shift is introduced in the probe pulse, which may be achieved, for instance, by selecting the modulator 108 to be of the acousto-optic type, where the pulsed output is taken from the first diffraction order, or higher. All orders other than zero of the output of such devices are frequency-shifted (up or down) with respect to the input light by an amount equal to (for first order) or integer multiple of (for second order or higher) the radio-frequency electrical input applied to them. Thus, as shown in FIG. 1, an intermediate frequency (IF) source 114 (e.g., a radio frequency oscillator) provides a driving signal for the modulator 108, gated by an IF gate 116 under the control of a trigger pulse 118. The optical pulse thus extracted from the modulator 108 is thus also frequency-shifted relative to the light input to the modulator 108 from the optical source 102, and therefore also relative to the local oscillator signal in the path 106.

The trigger 118 shown in FIG. 1 synchronizes the generation of the probe pulse with the acquisition by system 100 of samples of the backscatter signal generated by the sensor 112, from which the phase (and indeed the amplitude) information may be calculated. In various embodiments, the trigger 118 can be implemented as a counter within an acquisition system 140 that determines the time at which the next pulse should be generated by modulator 108. At the determined time, the trigger 118 causes the IF gate 116 to open simultaneously with initiating acquisition by the system 140 of a pre-determined number of samples of the phase information. In other embodiments, the trigger 118 can be implemented as a separate element that triggers initiation of the probe pulse and acquisition of the samples in a time-linked manner. For instance, the trigger 118 can be implemented as an arbitrary waveform generator that has its clock locked to the clock of the acquisition system 140 and which generates a short burst at the IF rather than the arrangement shown of an RF source 114 followed by a gate 116.

In other arrangements, the frequency difference between the probe pulse lunched into the fiber 112 and the local oscillator signal in the path 106 may be implemented in manners other than by using the modulator 108 to shift the frequency of the probe pulse. For instance, a frequency shift may be achieved by using a non-frequency-shifting modulator in the probe pulse path 104 and then frequency-shifting (up or down) the light prior to or after the modulator. Alternatively, the frequency shifting may be implemented in the local oscillator path 106.

Returning to the embodiment shown in FIG. 1, a circulator 120 passes the probe pulse into the sensing fiber 112 and diverts the returned light to a lower path 122, where it is directed to a coherent-detection system 123 that generates a mixed output signal. In an exemplary implementation, the coherent-detection system 123 includes a directional coupler 124, a detector 126 and a receiver 132. The directional coupler 124 combines the returned light in path 122 with the local oscillator light in the path 106. The output of the coupler 124 is directed to the detector 126. In the embodiment shown, the detector 126 is implemented as a pair of detectors 128 and 130 that are arranged in a balanced configuration. The use of a detector pair can be particularly useful because it makes better use of the available light and can cancel the light common to both outputs of the coupler 124 and, in particular, common-mode noise. The detector 126, or detector pair, provide(s) a current output centered at the IF that is passed to the receiver 132, such as a current input preamplifier or the transimpedance amplifier shown in FIG. 1, which provides the mixed output signal (e.g., the IF signal).

A filter 134 can be used to select a band of frequencies around the IF and the filtered signal can then be amplified by amplifier 136 and sent to a phase-detection circuit 152 that detects the phase of the mixed output signal (e.g., the IF signal) generated by the coherent-detection system 123 relative to an external reference, e.g., IF source 114. The phase-detection circuit 152 for extracting the phase of the mixed output signal can be implemented by a variety of commercially available devices, such as the AD8302, supplied by Analog Devices (of Norwood, Mass., USA). In the embodiment shown, the IF source 114 (which generates the driving signal used to shift the relative frequencies of the local oscillator and the backscatter signals by a known amount, which is related to the frequency of the driving signal) is also fed to the phase-detection circuit 152 to provide a reference. Thus, the phase-detector 152 provides an output that is proportional (modulo 360°) to the phase-difference between the backscatter signal (mixed down to IF) and the reference from the IF source 114. The output of circuit 152 is provided to an acquisition system 140 that is configured to sample the incoming signal to acquire the phase information therefrom. The trigger 118 time synchronizes the sampling of the incoming signal with the generation of the probe pulse.

The acquisition system 140 may include a suitable processor (e.g., general purpose processor, microcontroller) and associated memory device(s) for performing processing functions, such as normalization of the acquired data, data averaging, storage in a data storage 142, and/or display to a user or operator of the system. In some embodiments, the acquisition system 140 may include an analog-to-digital converter to digitize the signal and the amplitude information then can be acquired from the digital data stream.

In general, the technique for detecting phase in the backscatter signal, such as for measuring changes in local strain along the length of the sensing fiber, can be summarized as follows. The optical output of a highly-coherent optical source (e.g., source 102) is divided between two paths (e.g., paths 104 and 106). Optionally, the carrier frequency of the signal in one or both of the paths may be frequency shifted to ensure that the carrier frequencies of the optical signals in the two paths differ by a known amount.

Regardless of whether frequency-shifting is employed, the signal in the first path (e.g., path 104) is modulated to form a pulse, which optionally may be amplified. The pulse is then launched into the sensing fiber (e.g., fiber 112), which generates a backscatter signal in response to the pulse. The backscatter return is separated from the forward-traveling light and then mixed with the light in the second path (e.g., path 106) onto at least one photodetector to form a mixed output signal, such as an intermediate frequency (IF) signal. In embodiments in which there is no frequency shift, this IF is at zero frequency. Based on a known speed of light in the sensing fiber, the phase of the IF at selected locations along the fiber can be extracted and measured. The difference in phase between locations separated by at least one pre-defined distance interval along the fiber is calculated. As an example, the phase may be measured at locations every meter along the fiber and the phase difference may be determined between locations separated by a ten meter interval, such as between all possible pairs of locations separated by ten meters, a subset of all possible pairs of locations separated by ten meters, etc. Finally, at least one more optical pulse is launched into the sensing fiber, phase information at locations along the fiber is extracted from the resultant mixed output signal (created by mixing the backscatter signal with the light in the second path), and the phase differences between locations are determined. A comparison is then performed of the phase differences as a function of distance (obtained based on the known speed of light) along the fiber for at least two such probe pulses. The results of this comparison can provide an indication and a quantitative measurement of changes in strain at known locations along the fiber.

Although the foregoing discussion has described the cause of changes in the phase-difference of the backscatter signal as being strain incident on the optical fiber, other parameters, such as temperature changes, also have the ability to affect the differential phase between sections of the fiber. With respect to temperature, the effect of temperature on the fiber is generally slow and can be eliminated from the measurements, if desired, by high-pass filtering the processed signals. Furthermore, the strain on the fiber can result from other external effects than those discussed above. For instance, an isostatic pressure change within the fiber can result in stain on the fiber, such as by pressure-to-strain conversion by the fiber coating.

Regardless of the source of the change in phase differentials, phase detection may be implemented in a variety of manners. In some embodiments, the phase detection may be carried out using analog signal processing techniques as described above or by digitizing the IF signal and extracting the phase from the digitized signal.

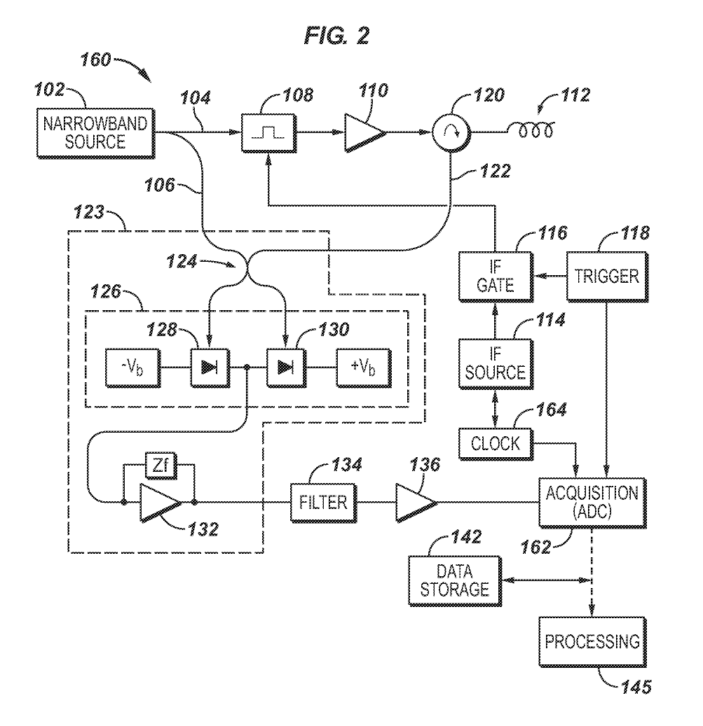

For instance, FIG. 2 shows an embodiment for a phase-measuring coherent-detection OTDR system 160 that uses digital signal acquisition techniques. To detect phase, the system 160 includes a high-speed analog-to-digital converter (ADC) 162 driven by a clock 164 and triggered by the same trigger source 118 that is used to initiate the optical probe pulse. The clock 164, which controls the sampling rate of the ADC 162, can be derived from the same master oscillator that is used to derive the IF source 114 in order to ensure phase coherence between the backscatter signal and the timing of the digital samples.

As an example, commercially available acousto-optic modulator drive frequencies include 40, 80 or 110 MHz. The resulting IF signal can conveniently be sampled at 250 MSPS (mega samples/s), a sampling frequency for which a number of high quality 12-bit analog-to-digital converters (ADCs) are available, for example from Maxim Integrated Circuits (MAX1215) or Analog Devices (AD9626 or AD9630). ADCs with higher sampling rates are available commercially from companies such as Maxim Integrated Circuits or National Semiconductor, and sampling rates in excess of 2GSPS (giga samples per second) can be purchased off the shelf, with somewhat lower resolution (8-10 bit). Preferably, the sampling rate of the ADC 162 is set to be several times the IF frequency, for example 4-5 times the IF frequency, but techniques known as sub-sampling, where this condition is not met can also be employed within the scope of the present invention. Thus, in the system 160 shown in FIG. 2, two frequencies are used: one to drive the ADC 162 and the other for the IF source 114. Both frequencies can be derived from a common oscillator using one or more phase-locked loops and/or frequency dividers. An alternative approach is to drive the AOM 108 from an arbitrary waveform generator which synthesizes the RF signal to drive the AOM 108 and which itself is synchronized in its clock to the sampling clock 164. The digital data stream thus generated by the ADC 162 may be processed by a processing system 145 on the fly to extract a phase estimate from the incoming data. Alternatively, the data may be stored in a data storage 142 for later processing by the processing system 145.

The processing system 145 can include a suitable processor (e.g., general purpose processor, microcontroller) and associated memory device(s) for performing processing functions, such as normalization of the acquired data, data averaging, storage in a data storage 142, and/or display to a user or operator of the system.

In some embodiments, the phase may be extracted from the digital stream by dividing the data stream into short data windows, representative of approximately one resolution cell in the sensing fiber (the windows may be shaped by multiplication by a window function to minimize the leakage in the frequency domain); extracting the signal at the IF frequency from each data window; and calculating the argument of the signal in each window.

This computation can be simplified if there is an integral relationship between the number of data points in the window and the number of cycles of the IF signal in that same window. For example, if the sampling rate is 250 MSamples/s and the IF frequency is 110 MHz, then by choosing the window to be equal to 25 data points, the duration of the window is 100 ns, and this contains exactly 11 cycles of the IF signal. It is then not necessary to carry out a full Fourier transform, but only to extract the desired frequency. In this case, the following sum over a window consisting of Pts points, with a sampling frequency Fₛ and an IF frequency f₁, will provide a complex vector X representing the value of the backscatter signal averaged over the length of fiber defined by array Ar. Here, j is the square root of −1.

$$X ( Ar ) := {\sum }_{k = 0}^{Pts - 1} {Ar}_{k} \cdot exp ( - 2 \cdot π \cdot j \cdot k \cdot \frac{{f}_{1}}{{F}_{s}} ) \cdot \frac{2}{Pts}$$

It is readily recognized that the expression above is equivalent to taking the Fourier transform of the window and then selecting the frequency component f₁. The modulus of X is the amplitude of the backscatter signal and its argument is the phase. If a full Fourier transform is used to calculate the complex spectrum, then estimates of the phase are available at a number of frequencies around the nominal values of the IF. The inventors have observed that these neighboring frequencies are all phase related and can thus be used collectively to provide the best estimate of the phase of the backscattered light at the point of interest.

It should be noted that in some embodiments, the spectrum of the backscattered light may be found to be broadened considerably relative to that of the light launched into the fiber. The launched light has a spectrum that is that of the source convolved with the spectrum imposed by the modulation used to generate the pulse (and thus has a spectral width inversely proportional to the pulse duration). However, the spectrum for an individual laser pulse scattered at a particular location can be considerably wider and displaced in its peak from the nominal IF value. The reason for this displacement and broadening of the spectrum is that the intrinsic phase of the backscattered signal is, for a given strain of the fiber and frequency of the optical source, a unique attribute of the section of fiber. It follows that each section of fiber (as determined, for example, by the pulse duration) has a unique and generally different backscattered phase. Therefore as the interrogating pulse travels along the fiber, the phase of the backscatter fluctuates according to the intrinsic phase of the section of fiber that it occupies. This phase fluctuation broadens the spectrum of the scattered light. The degree to which this spectral broadening occurs is inversely proportional to the pulse duration. In heterodyne coherent-detection OTDR, it is desirable for the pulse duration to be at least several cycles of the IF, in order to limit the relative bandwidth of the backscattered spectrum.

It will be recognized that other digital signal processing techniques known to those of skill in the art also can be used to extract the phase of the IF signal.

For instance, in some embodiments, another example of a digital technique for extracting the phase is to calculate the Hilbert transform of the incoming signal, which provides a so-called analytic signal (a complex signal including a real term and an imaginary term). The phase may be calculated directly by forming the arc tangent of the ratio of the imaginary to real parts of the analytic signal.

There are several other techniques that can be used to extract the phase from a digitized intermediate frequency signal.

In some embodiments, the amplitude information from the backscatter signal is still present and can be used to assist the signal processing. The amplitude contains exactly the same information as would be obtained from other OTDR systems where only the intensity of the backscattered signal is acquired. The amplitude information is to some extent complementary to the phase information and can be used to supplement the phase data obtained from the main thrust of this disclosure.

As an example, in some applications, such as in seismic acquisition applications, repeated measurements of the backscattered signal under identical conditions are conducted and the results averaged in order to improve the signal-to-noise ratio. Since the frequency of the laser or the condition of the fiber can drift slowly with time, regions where the amplitude was weak (and the signal quality is thus poor) for one acquisition can become regions of strong signal in a later acquisition. The amplitude information can thus be used to provide an indication of signal quality and this indication can then be used to allocate a weighting to the acquired signals. For instance, when averaging successive acquisitions taken under identical conditions, a higher weighting can be allocated to those acquisitions where the amplitude information is indicative of a strong (i.e., high quality) signal, while a lower weighting is allocated to those acquisitions wherein the amplitude information is indicative of a weak (i.e., low quality) signal. In addition to indicating the signal quality of a particular acquisition, the amplitude information can be used to provide an indication of the signal quality at each location along the sensing fiber. Based on these indications, the results obtained from successive acquisitions can be weighted for each location and each acquisition and then combined in a manner that provides an optimized measurement of the desired parameter.

The amplitude information can also be used in other manners to enhance the acquired data. As another example, the amplitude measurement is specific to each location, whereas the phase measurement includes a local element combined with an increasing phase as a function of distance. Thus, if there is a single point of disturbance along the sensing fiber, the disturbance will affect the amplitude only locally at the disturbance point, but the local disturbance will affect all the phases beyond that point. (This is why phase differences are determined to provide an indication of the desired parameter rather than phase information at a particular location.) Thus, examination of the amplitude information in conjunction with the phase information can facilitate distinguishing the effect of a small local perturbation from that of wider disturbance affecting the entire differentiating interval. Consequently, consideration of the amplitude information along with the phase difference can support a more detailed interpretation of the acquired data.

### Laser and Clock Phase Noise

In some of the discussed embodiments, the phase measurement relies on comparing the phase of light emitted by the laser essentially at the time of detection with the light scattered at the point of interest (and thus emitted substantially earlier, with a time delay given by approximately 10 μs/km). The coherence of the optical source is thus a greater consideration in some embodiments than in embodiments where the relative phase is determined between two pulses that are launched potentially a short time apart. Although, this problem can be alleviated to some extent by calculating the difference in the phase between separate, but close, regions of the fiber, a poor source coherence causes the phase measured at the IF to move rapidly, creating difficulties in acquiring an accurate estimate of the phase. In particular, if the source exhibits considerable phase noise, phase modulation to amplitude conversion occurs, which gives rise to spectral broadening.

In some embodiments, optical sources having suitable coherency to overcome this problem include distributed feedback fiber lasers, and certain solid-state lasers, such as non-planar ring lasers, and semiconductor distributed feedback lasers (especially if the latter employ additional line-narrowing, such as Pound-Drever-Hall stabilization).

In some embodiments, a Brillouin laser may be used as the optical source. A Brillouin laser is a ring-resonant fiber structure into which a pump light is launched. The output, at the Brillouin frequency (shifted down relative to the pump light by some 11 GHz for typical fibers pumped at 1550 nm), is narrowed through several processes. Improvements of more than one order of magnitude in the source linewidth (relative to the linewidth of the pump) have been reported.

### Differential Phase

The phase of the backscatter at each location along the fiber is a random function of the laser frequency and the state of the fiber. Thus the phase of the backscatter varies randomly if a fiber is strained. However if one compares the phase Φ_{A} measured at section A, with the phase measured at section B, Φ_{B}, then the change in the phase difference Φ_{A}−Φ_{B} is related to three components, namely Φ_{A, -B} and Φ_{L}. The Φ_{A} and Φ_{B} components vary randomly with applied strain, whereas the contribution Φ_{L} from the portion between sections A and B is linear with applied strain. It follows that the strain-phase transfer function is not quite linear, but that the linearity improves rapidly as the ratio of the distance A-B divided by the length of individual sections A and B increases. In particular, as the sections A and B are made smaller, the amount of strain that is required to vary their intrinsic phase is increased and therefore reducing the length of these sections aids in improving the linearity, all other parameters being equal. In general, there is a trade-off between the spatial resolution that can be achieved and the linearity, since for a given minimum pulse duration, the larger the differencing interval the better the linearity, but the worse the spatial resolution (it should be noted that the signal is also proportional to the duration of the differencing interval, for uniform acoustic fields). Generally, the ratio of the differencing interval to the pulse duration falls in the range of 2 (where there is mainly interest in tracking events) to 10 (where linearity is more important than in simple event tracking applications. It should be understood, however, that other ratios may be used, including higher ratios.

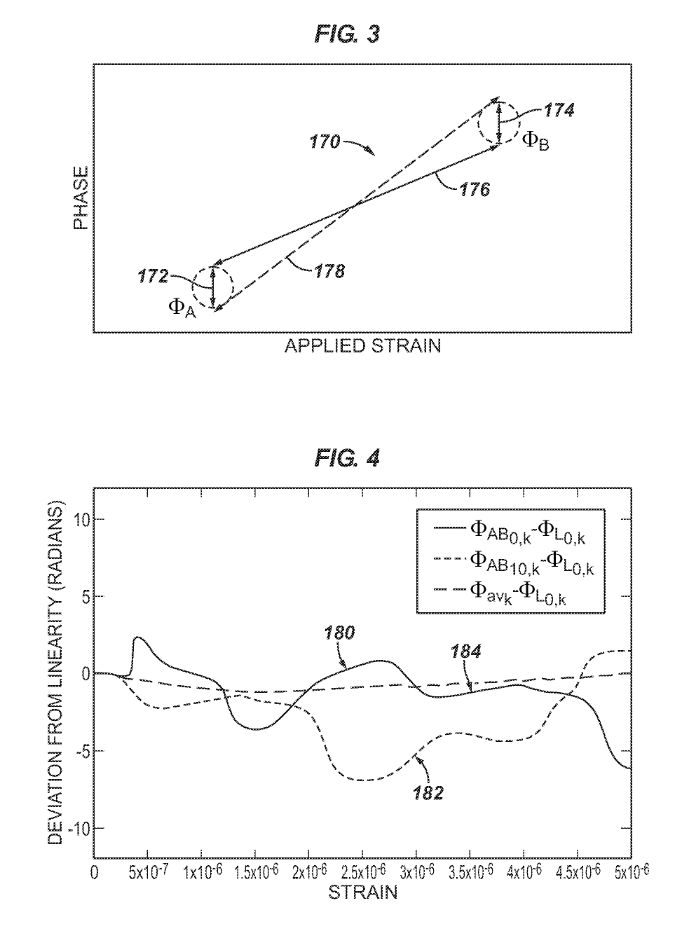

This situation is illustrated in the graph 170 of FIG. 3 which plots phase on the vertical axis against strain on the horizontal axis to illustrate the phase response of a section of uniformly strained fiber. The double-headed arrows 172 and 174 denote the range of phase that each of sections A and B of the sensing fiber can return. The solid line straight arrow 176 and dashed line straight arrow 178 illustrate the extremes of the possible overall transfer functions that can exist. The phase response of sections A and B is constrained to the region −π to π, whereas the linear phase component Φ_{L} has no particular limit. On average, the transfer function will have a slope determined by Φ_{L}, but this may be distorted by the strain on the ends of the section.

### Multiple Frequencies

The characteristic phase of each section A and B is a function of the source frequency, in the same way as the amplitude of the backscatter in these regions is a function of source frequency. Thus, if the measurement were repeated with a different source frequency, then the strain sensitivity of the linear contributions Φ_{L} for each of these measurements will be essentially the same, whereas the phase contributions Φ_{A} and Φ_{B} for the sections will vary randomly. By averaging the differential phase measurement for two or more optical frequencies, the linear contributions for each will add in proportion to the number of frequencies, whereas each of the Φ_{A} and Φ_{B} contributions remains constrained within a −2π to 2π range and their sum grows only in proportion to the square root of the number of frequencies involved.

As an example of this differential phase technique, FIG. 4 shows the deviation from linearity modeled for a sensing fiber where the pulse duration is 100 ns (equivalent to 10 m of fiber), and the analysis assumes that the zones analyzed are such that the centers of the sections defining each strained zone are also 10 m apart. The simulation covers a strain range of 5με, which for a pure linear response would result in a maximum phase change of some 74.5 radians for a probe wavelength in the region of 1550 nm. It may be seen in FIG. 4 that the response for single interrogating frequencies (represented by the solid curve 180 and the dotted curve 182) show departures from linearity in the range indicated above. However, the black, broken curve 184 is the average measurement for 20 separate interrogating frequencies. A significant improvement in linearity is observed. Of course, the precise deviation from linearity is a function of the specific arrangement of the microcrystalline structure of the glass forming the specific sections of fiber A and B. While the improvement can only be measured statistically, the deviation is expected to be reduced in proportion to the square root of the number of independent interrogating frequencies available. In order to count as independent, the interrogating frequencies are separated by at least the reciprocal of the pulse duration. In order most efficiently to reduce the non-linearity by averaging the results of multiple interrogation frequencies, the frequency separation is at least this value.

### Multi-Resolution and Pulse Separation

If the coherent backscatter signals are acquired along the entire length of the fiber, the data can be processed holistically to improve the strain linearity. As a very simple example, if the strain is found to be localized to a particular region, then the end regions A and B can be selected from the acquired data sets to be separated from the strained zone, such that they are unaffected by the strain. If this can be achieved, the strain measured in the region separating them is perfectly linear.

More generally, the strain can be estimated from a first A-B separation, which will contain some non-linearity. A map of strain thus obtained provides a general indication of a strain/distance function. The phase sensitivity to strain is a random function of position along the fiber and interrogating frequency. However, if the fiber is interrogated at multiple frequencies separated by less than the amount required for independence (as discussed earlier), then a map of sensitivity to strain of the phase for each part of the fiber can be built and used to correct the A and B sections for each part of the fiber and thus improve the accuracy of this first estimated strain distribution.

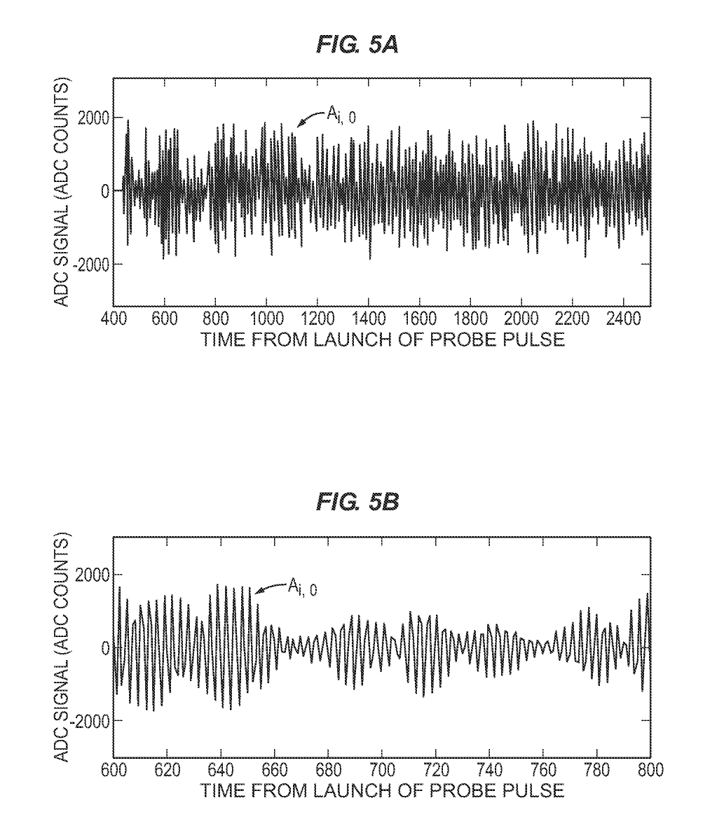

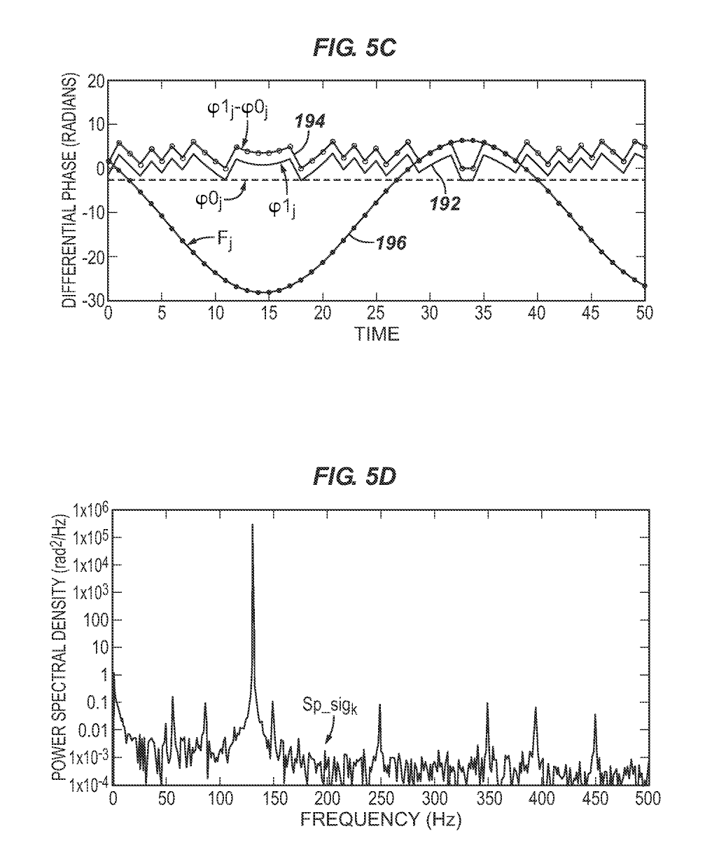

As an example, FIG. 5A shows a heterodyne coherent Rayleigh backscatter signal acquired from a single laser pulse. In this case, the pulse duration was about 50 ns, the IF was 100 MHz and the sampling rate was 300 MSPS. FIG. 5B shows a magnified portion of this signal between points 600 and 800, which corresponds to a fiber length of about 66 meters. The phase of the IF is clearly detectable and the envelope can be seen to vary along the fiber.

FIG. 5C shows the detected phase φ₀ for a sequence of backscattered signals (50 laser pulses in this case) just before (line 190) a sinusoidal disturbance at point 705 along the fiber. In this case, the disturbance was centered on point 705, and the phase was estimated in a window centered on 60 points (approximately 20 m) upstream from the disturbance. The curve 192 shows the phase estimated after the disturbance for the same laser pulses and thus the same backscatter signals (again 20 m downstream of the disturbance). The curve 194 shows the difference between these phase estimates, as a function of backscatter trace number (which corresponds to time). Finally, the curve 196 shows the unwrapped phase derived from the differential phase (curve 194).

The final figure in the sequence, FIG. 5D, shows the spectrum derived from the above data (several thousand pulses were acquired, rather than just the 50 pulses shown in FIG. 5C for clarity). It can be seen that a very linear signal recovery is achieved, with some 80 dB signal-to-noise ratio and 60 dB above parasitic acoustic sources at 60, 85, 150, 250, 350, 395 and 450 Hz. This demonstrates the capability of the techniques disclosed here to perform high-quality measurements of predictable transfer function.

### Polarization Discrimination

The coherent detection process is intrinsically polarization-sensitive in that the signal produced is the product of the electric field vectors of the two optical inputs and therefore only that component of the backscattered light that is aligned with the local oscillator signal is detected. The orthogonal component is rejected. However, it is possible to split the incoming backscattered signal into any two orthogonal polarization states and mix each of these with a suitably aligned local oscillator signal. Again, commercially available components are available for this function (for example from Optoplex or Kylia, mentioned above). Using this approach has two distinct benefits. Firstly, this arrangement avoids polarization fading (i.e., the weakening of the signal when the polarizations of the backscatter signal and LO signal are not the same). However it should be noted that with Rayleigh backscatter in silicate glasses, the depolarization of the scattered light ensures that there is always a minimum of approximately 20% of the electric field of the scattered light in the orthogonal polarization state from the strongest, so this issue is not critical. More importantly, in some cases, the two polarizations may carry different information. This is particularly the case when asymmetric influences are applied to the fiber, such as a side force, which tends to act to vary the difference in propagation speed between the two polarization modes of the fiber (i.e. it alters the birefringence of the fiber). This applies to fibers that are nominally circularly symmetric (as are most conventional telecommunications fibers). However, special fibers can exploit the property of a polarization-diverse acquisition system more specifically.

For example, side hole fiber has been proposed and used for a number of years for making pressure measurements. As its name implies, this type of fiber consists of a core with a pair of holes placed symmetrically on either side of this core. This structure responds asymmetrically to isostatic pressure, with the birefringence increasing with increasing pressure. By launching light on both axes of such a fiber, and measuring the differential phase on each axis separately, the effects of axial strain transients (to first order common to both axes) and of isostatic pressure waves (to first order differential to the two axes) can be separated. This leads to several applications in which a side-hole fiber can be employed. For example, if the fiber is closely coupled to an earth formation, a p-wave propagating within the formation will appear as a pressure wave and thus be largely differential between the two optical axes of the fiber. In contrast, an s-wave, polarized along the fiber axis, will apply a mainly axial strain disturbance that can be detected as an essentially common signal on both axes. It is therefore possible to separate these two wave types, which has applications in, for example, seismic monitoring of hydrocarbon reservoirs. Other structures, such as asymmetric micro-structured fibers, have also been shown to produce asymmetric phase changes in response to pressure changes and could thus be used instead of pure side-hole fibers.

Another example of a special fiber that can be used is a high birefringence (HB) fiber. This type of fiber is designed to maintain polarization of light launched on one of the principal axes. There are many designs of such fibers, but one class of HB fiber includes stress-applying rods on either side of the core. These stress applying regions are designed to have a much higher expansion coefficient than that of the rest of the fiber, so an asymmetry is built into the fiber. This produces a large birefringence, which decreases the coupling between the polarization states of the lowest order mode and thus maintains polarization. Similarly to a side hole fiber, the response of an HB fiber to axial stress and to temperature variations is such that by measuring the phase disturbance on each axis separately, the effects of temperature (significant differential component as well as a common component) and strain (largely, but not entirely, common to the two axes) may be separated and thus a disturbance can be ascribed, after calibration of the fiber response, to one or both of a strain or temperature transient. This would allow detected events better to be interpreted. For example, an inflow of gas coming out of solution would be expected to produce a temperature decrease (caused by the Joule-Thomson effect) and possibly such vibration caused by flow noise. In contrast, other events might be purely acoustic or temperature-transient.

Yet another example of a special fiber is a micro-structured fiber, which is a fiber with arrays of holes surrounding the region where the light is guided. Such fibers can be designed to be asymmetric (as mentioned above in the context of pressure sensing) and they also allow the electric field of the guided optical wave to interact with whatever medium is placed in the holes. Typically, this medium is air, but if these holes (or just some of them) are filled with a material that responds, in its refractive index, to an external field, then this field can be sensed by the guided wave. Thus, for example, if the material is electro-optic, its refractive index will change with applied electric field and influence the phase of the light travelling in structure. Likewise, a material that exhibits a refractive index change with applied magnetic field would modulate the phase of the guided light. Although these concepts have been disclosed by others, they have not been applied in the context of an interrogation by coherent Rayleigh backscatter. This approach is particularly suited to long fibers where it is not known where an interaction might take place.

Several of these concepts can be combined for example with a multicore fiber, where a single glass structure can encompass several cores, some with stress-birefringence, others arranged to respond differentially to pressure. While some cross sensitivity is to be expected, as long as the information can be separated (i.e. the data produced is well conditioned such that a transfer matrix from physical inputs to measured phases can be inverted), data on, for instance, pressure, strain and temperature transients can readily be separated.

In some embodiments, the systems and techniques described herein may be employed in conjunction with an intelligent completion system disposed within a well that penetrates a hydrocarbon-bearing earth formation. Portions of the intelligent completion system may be disposed within cased portions of the well, while other portions of the system may be in the uncased, or open hole, portion of the well. The intelligent completion system may comprise one or more of various components or subsystems, which include without limitation: casing, tubing, control lines (electric, fiber optic, or hydraulic), packers (mechanical, sell or chemical), flow control valves, sensors, in flow control devices, hole liners, safety valves, plugs or inline valves, inductive couplers, electric wet connects, hydraulic wet connects, wireless telemetry hubs and modules, and downhole power generating systems. Portions of the systems that are disposed within the well may communicate with systems or sub-systems that are located at the surface. The surface systems or sub-systems in turn may communicate with other surface systems, such as systems that are at locations remote from the well.

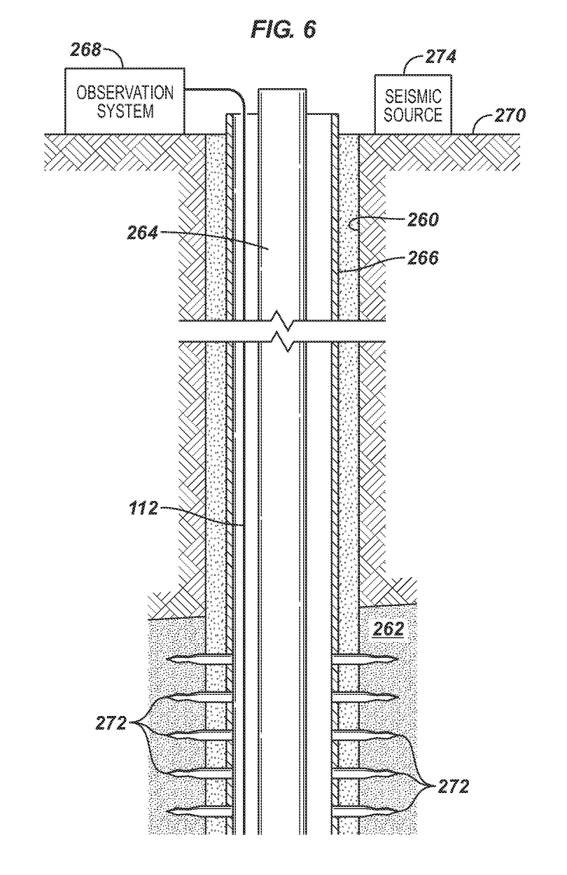

For example, as shown in FIG. 6, a fiber optic cable, such as sensing fiber 112, may be deployed in a wellbore 260 to observe physical parameters associated with a region of interest 262. In some embodiments, the sensing fiber 112 may be deployed through a control line and may be positioned in the annulus between a production tubing 264 and a casing 266 as shown. An observation system 268, which includes the interrogation, detection and acquisitions systems for a coherent phase-detection OTDR system (e.g., systems 100, 160), may be located at a surface 270 and coupled to the sensing fiber 112 to transmit the probe pulses, detect returned backscatter signals, and acquire phase information to determine the parameters of interest (e.g., strain, vibration) in the manners described above.

In the embodiment shown in FIG. 6, to reach the region of interest 262, the wellbore 260 is drilled through the surface 270 and the casing 266 is lowered into the wellbore 260. Perforations 272 are created through the casing 266 to establish fluid communication between the wellbore 240 and the formation in the region of interest 262. The production tubing 264 is then installed and set into place such that production of fluids through the tubing 264 can be established. Although a cased well structure is shown, it should be understood that embodiments of the invention are not limited to this illustrative example. Uncased, open hole, gravel packed, deviated, horizontal, multi-lateral, deep sea or terrestrial surface injection and/or production wells (among others) may incorporate a phase coherent-detection OTDR system as described. The fiber optic sensor for the OTDR system may be permanently installed in the well or can be removably deployed in the well, such as for use during remedial operations. In many applications, strain and pressure measurements obtained from the region of interest using a phase coherent-detection OTDR system may provide useful information that may be used to increase productivity. For instance, the measurements may provide an indication of the characteristics of a production fluid, such as flow velocity and fluid composition. This information then can be used to implement various types of actions, such as preventing production from water-producing zones, slowing the flow rate to prevent coning, and controlling the injection profile, so that more oil is produced as opposed to water. The strain and pressure measurements also can provide information regarding the properties of the surrounding formation so that the phase coherent-detection OTDR system can be used in a seismic surveying application.

Towards that end, a phase coherent-detection OTDR system can provide substantial advantages for seismic exploration and seismic production monitoring applications. For instance, seismic surveying applications, and particularly downhole seismic monitoring applications, employ seismic sources (e.g., seismic source 274 in FIG. 6) to generate seismic signals for detection by an acoustic sensor, such as a fiber optic sensor (e.g., fiber 112 in FIG. 6) which is configured to respond to acoustic forces incident along its length and which is deployed downhole (e.g., in wellbore 260 in FIG. 6). Two different types of seismic sources are generally employed: impulsive sources (e.g., air guns, explosives, etc.), which may be either deployed at the surface (as shown in FIG. 6) or downhole in the wellbore, and vibroseis sources. A vibroseis source is generally implemented by one or more trucks or vehicles that move across the surface and, when stationary, shaking the ground with a controlled time/frequency function, which typically is a linearly varying frequency or “chirp.” When impulsive sources are used, optical signals captured from a fiber optic sensor during seismic monitoring can be easily cross-correlated with the original acoustic signal incident on the sensor since the firing of the impulsive source is a discrete event. However, for vibroseis sources, the captured signals must be linearly related to the acoustic signals incident on the fiber in order to perform the cross-correlation between the captured signals and the original chirp signal. Because the phase coherent-detection OTDR systems discussed above exhibit a linear and predictable strain/phase transfer function, embodiments of the phase coherent-detection OTDR system are particularly well suited for seismic monitoring applications that generate time-varying acoustic signals, such as chirps. Yet further, because of this linear, predictable relationship between the acoustic signals that impart a strain on the sensor and the resulting optical signal, beam-forming methods can be employed to filter the incoming acoustic waves by angle, thus providing for more precise characterization of the properties of the surrounding geologic formation.

Embodiments of the phase coherent-detection OTDR systems discussed above can also be employed in applications other than hydrocarbon production and seismic or geologic surveying and monitoring. For instance, embodiments of the phase coherent-detection OTDR systems can be implemented in intrusion detection applications or other types of applications where it may be desirable to detect disturbances to a fiber optic cable. As another example, embodiments of the phase coherent-detection OTDR systems can be employed in applications where the fiber optic sensor is deployed proximate an elongate structure, such as a pipeline, to monitor and/or detect disturbances to or leakages from the structure.

The embodiments discussed above employ coherent-detection OTDR techniques (generally, launching a narrow-band optical pulse into an optical fiber and mixing the Rayleigh backscattered light with a portion of the continuous light coming directly from the optical source) combined with phase measurements to measure a parameter of interest in the region in which the optical fiber is deployed. As discussed above, in some embodiments, the measured phases are differentiated over a selected differentiation interval and the time variation of these differentiated phase signals is a measure of the parameter of interest. As further discussed above, in various embodiments, multiple interrogation frequencies can be used to enhance the linearity of the measurement and to reduce the fading that otherwise is present in a coherent-detection OTDR system that employs a single interrogation frequency.

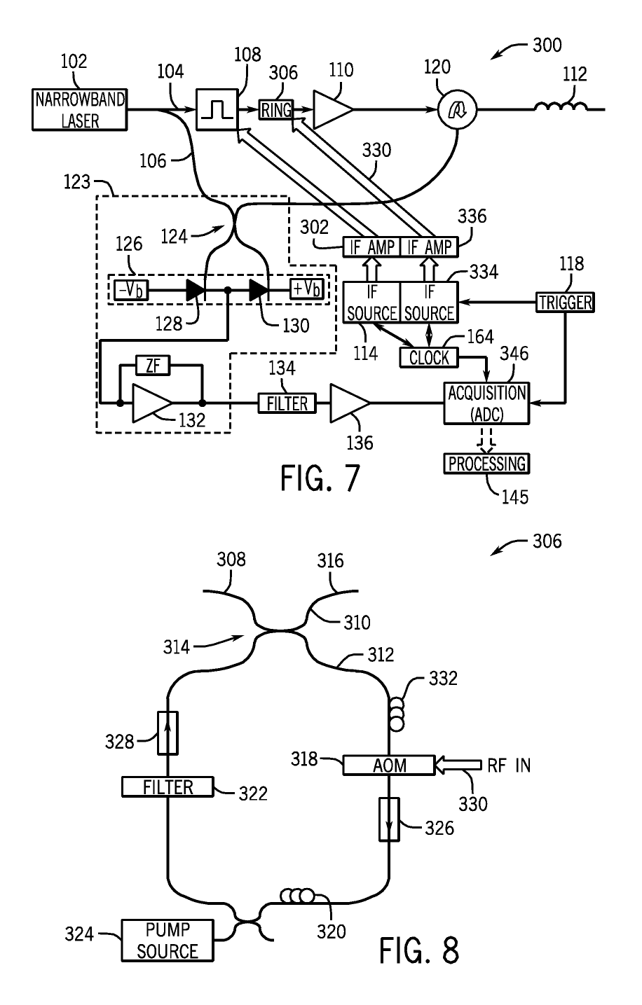

An exemplary arrangement of a phase-measuring coherent-detection heterodyne OTDR system 300 that employs multiple interrogation frequencies is illustrated in FIG. 7. In this embodiment, the output of the narrowband optical source 102 again is split into the probe path 104 and the local oscillator path 106. In the probe path 104, a modulator 108 (e.g., an acousto-optical modulator (AOM) operated in the first mode) extracts a pulse from the output of the optical source 102 on the probe path 104 and shifts its frequency in accordance with the frequency of the radio frequency (RF) signal applied to the modulator 108. In the embodiment shown, the RF signal is generated by the IF source 114 that is clocked by the clock 164 and triggered by the trigger source 118. The IF source 114 outputs a signal to an IF amplifier 302 that then applies the RF signal to an input of the modulator 108.

The shifted frequency pulse output by the modulator 108 is then provided as an input to a ring circuit 306, which generally operates to translate the frequency of the pulse provided at its input. An exemplary ring circuit 306 is shown in FIG. 8.

Turning to FIG. 8, the pulse at input 308 is split into two paths 310 and 312 by a coupler 314. In path 310, the pulse travels directly to the output 316 of the ring circuit 306. In the path 312, the pulse travels around a loop arrangement that includes a frequency shifting device 318, an optical amplifier 320 and a filter 322. The light passes several times around the loop, each pass resulting in a further frequency shift so that a comb of frequency (i.e., a pulse train) is output at the output 316. The optical amplifier 320 in the loop compensates the loss in the loop (including the splitting loss in the coupler 314 and transmission losses in the frequency shifter 318 and the filter 322). The filter 322 minimizes the buildup of amplified spontaneous emission which can reduce the effectiveness of the amplifier 320. The filter 322 generally has a bandwidth that is similar to the frequency range of the train of pulses (or comb) that is output at output 316 of the ring 306. The filter 322 thus limits the extent of the frequency comb.

In the embodiments shown in FIGS. 7 and 8, the narrowband optical source 102 preferably operates in the range of 1550 nm (although other wavelengths are contemplated). In such embodiments, a suitable optical amplifier 320 in the ring circuit 306 is an Erbium doped fiber amplifier, which is pumped by a pump source 324 at approximately 1480 nm or 980 nm. In other embodiments, the optical amplifier 320 can be implemented as a semiconductor optical amplifier instead of a fiber amplifier. The embodiment in FIG. 8 also includes one or more isolators 326, 328 to ensure that the ring 306 operates only in the clockwise direction.

The gain of the ring 306 is arranged approximately to match the losses in the ring 306. In embodiments in which the optical amplifier 320 is a rare-earth-doped fiber amplifier, the gain of the ring 306 may be set approximately by selection of the length of the amplifying fiber 320. Generally, this length is selected to be slightly longer than needed to precisely match the cavity losses when at maximum gain. Precise control of the gain of the ring 306 can be accomplished by controlling the power of the pump source 324 applied to the fiber amplifier 320 and/or the RF power 330 delivered to the frequency shifter or AOM 318, which controls its transmission efficiency. The duration of the pulse train output from the ring 306 and, thus, the number of pulses in the train, can be controlled by the duration of the RF signal applied to the AOM 318.

The exemplary arrangement in FIG. 8, further includes a delay line fiber 332 in the loop to ensure that the duration of the round trip tᵣ of a pulse is longer than a pulse duration. In systems in which a variety of pulse durations will be used, the loop (including the delay) is arranged so that tᵣ is longer than the broadest pulse envisaged. In such an arrangement, each pulse that exits the ring 306 has a distinct frequency. In other arrangements, each pulse can contain more than one frequency. However, when the ring is arranged so that the pulse contains one frequency, the power launched into each frequency can be optimized. In general, the limitation on the power that can be launched results from non-linear effects, such as stimulated Raman and Brillouin scattering, self-phase modulation, modulation instability. Some of these (e.g. stimulated Raman scattering) are limited by the total power in the pulse. Thus by splitting the energy between multiple pulses, this particular limitation is circumvented. Yet other non-linear effects, such as four-wave mixing, can occur when multiple frequencies propagate together.

Returning to FIG. 7, the RF signal 330 applied to the AOM 318 in the ring 306 is generated by IF source 334, which is clocked by clock 164 and triggered by trigger source 118. The output of the IF source 334 is amplified by IF amplifier 336 and then applied to the AOM 318 of the ring 306.

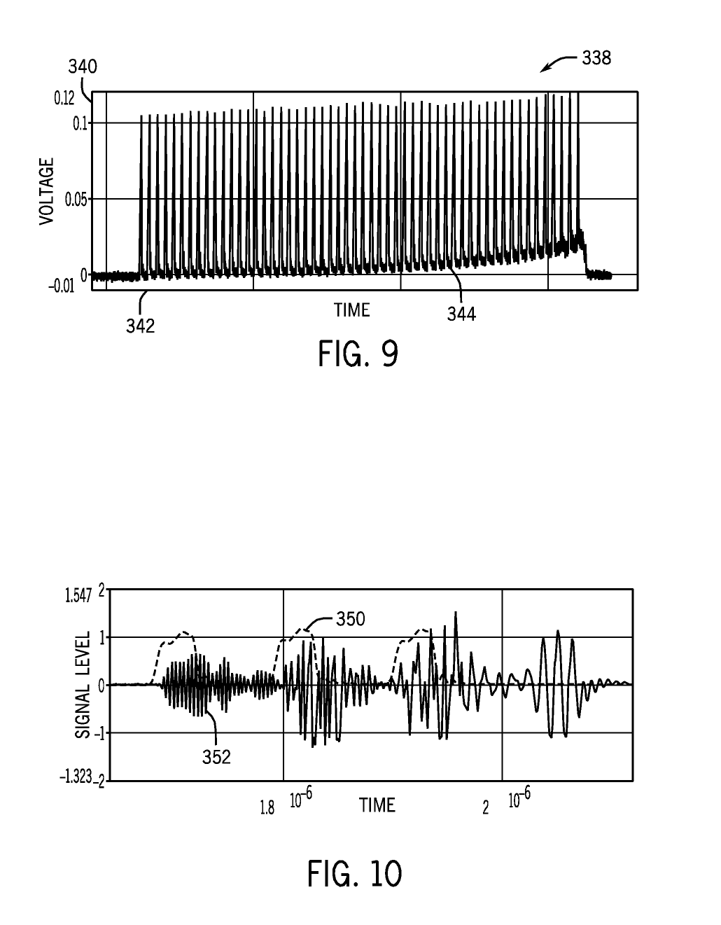

An example of a train of pulses 338 that can be output from the ring 306 is shown in FIG. 9. In this example, the vertical axis corresponds to voltage from a photodiode connected to the output of the ring 306 to detect the pulses 338. The horizontal scale 342 is time, where the major divisions represent intervals of 5us. As can be seen in FIG. 9, each of the pulses are separated by approximately tᵣ=275 ns. The pulse train 338 includes a total of 54 pulses, including the initial unshifted pulse that does not travel around the loop of the ring 306, thus demonstrating that a long comb can be generated. The rise in the baseline 344 shown in FIG. 9 is due to amplified spontaneous emission in the ring 306.

### Limitations

Referring again to FIGS. 7 and 8, the electrical signal that is generated by the optical receiver 132 will contain frequencies limited on the one hand by the number of pulses circulated in the ring 306 and, on the other hand, by the bandwidth of the receiver 132. In addition, the ability of the acquisition system 346 to digitize the electrical signal generated by the receiver 132 fast enough to ensure no aliasing occurs is another limitation. For instance, if the acquisition system 346 were limited to sampling the output from the receiver 132 at 2 gigasamples per second (GSPS), the maximum available bandwidth would be just under 1 GHz. For a frequency spacing between pulses in the pulse train of 40 MHz, these limitations would allow almost 25 comb lines (i.e., frequencies) to be used. Thus, the digitization rate of the acquisition system 346 is the dominant limiting factor that defines the limits on the number of frequencies that the ring 306 of FIG. 8 can deliver simultaneously. Commercial ADCs are available at 12 bit resolution at sampling rates up to 3.6 GSPS (e.g., part number AD12D1800RF available from National Semiconductor). As faster devices become available, the digitization rate will become less of a factor. However, by displacing the frequency of the optical source 102 on successive acquisitions, further frequencies can be collected in subsequent acquisitions. Arrangements for increasing the number of frequencies acquired quasi-simultaneously will be discussed below.

An embodiment similar to that of FIGS. 7 and 8 was assembled, with AOM 108 providing a positive frequency shift of 110 MHz and AOM 318 a negative shift of −40 MHz. As a result the first three pulses to emerge from the ring 306 and into the sensing fiber 112 were at 110 MHz, 70 MHz and 30 MHz.

The pulse shapes, recorded on an oscilloscope as trace 350, are shown in FIG. 10. The pulses were acquired by adding a 1% tap coupler between the amplifier 110 and the circulator 120 of the system 300 of FIG. 7 and detecting the resulting sample of the probe pulses with a photodiode, itself connected to a fast digitizing oscilloscope. In this case the pulse separation is about 275 ns and the pulse duration, measured at full width, half height is about 95 ns. So the inverse of this duration, 10.5 MHz, is substantially less than the frequency separation.

These pulses were launched into a very short fiber 112 in this case (approximately 25 m) and the resulting backscatter, mixed with the local oscillator signal on path 106 and output as an electrical signal by the receiver 132 and captured on the oscilloscope is shown as the trace 352 in FIG. 10. Because the round trip time through the probed fiber 112 and back is about the same as the pulse separation, backscattered light Is received first for the initial pulse (110 MHz) and, successively for the other two (at 70 and 30 MHz). The beats at the high, medium and lowest frequency are clearly visible in the trace 352 of FIG. 10.

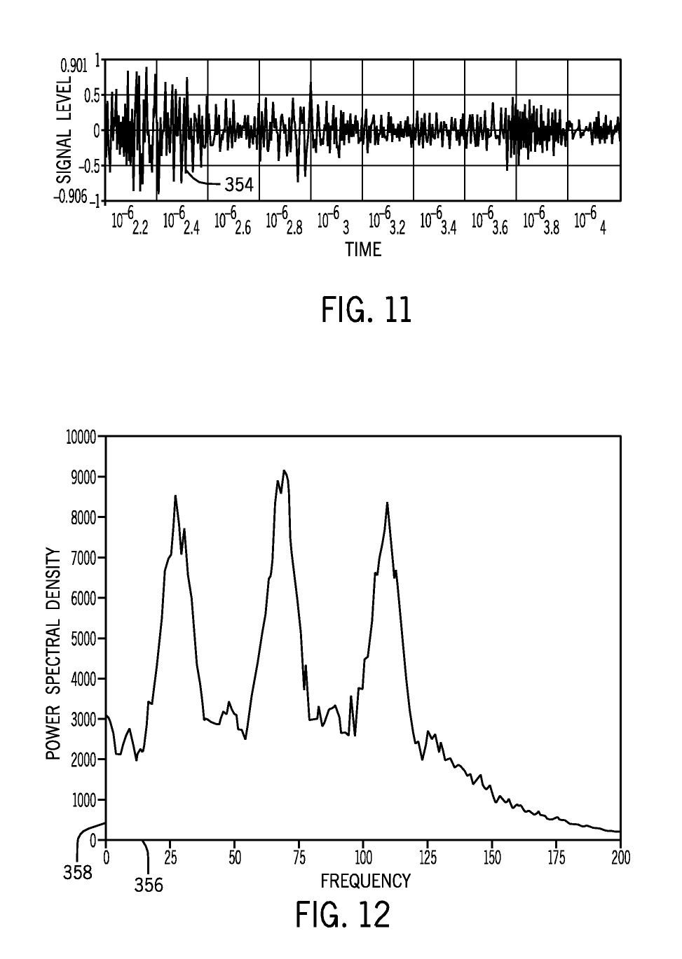

A segment of a backscatter trace 354 obtained for a longer fiber 112 with these same three probe frequencies is shown in FIG. 11. Even by eye, it can be seen that there is content from more than one frequency and that the overall fading is much less pronounced than is usual with a single probe frequency.

A spectral analysis of the backscatter trace 354 shown in FIG. 11 is given in FIG. 12. In FIG. 12, the horizontal axis 356 corresponds to frequency (MHz), and the vertical axis 358 corresponds to power spectral density (arbitrary units).

### Phase Extraction—WFT Banding

In the case of a single probe frequency, there are several means of extracting the phase of the backscatter signal. When multiple frequencies are used to interrogate the sensing fiber, phase extraction can be performed using the Windowed Fourier transform (WFT) described above. In the case of multi-frequency probe pulses, all frequencies can be separated in a single Fourier transform and their phase and amplitude information is available directly. Generally the phase information is used to estimate the signal of interest, while the amplitude may be used to weigh the contribution of each frequency, since it provides a location specific measure of the strength of that signal. This processing to extract the phase information can be performed in the processing system 145.

Alternative phase extraction methods also can be implemented. For example, the Hilbert transform may be performed in the digital domain by taking a Fourier transform of the time domain signal which is then transferred to the frequency domain, setting the amplitude coefficients of the negative frequencies to zero and then reverting to the time domain through an inverse Fourier transform. If, during this procedure, in the frequency domain a series of filters is applied to select specific frequency bands each corresponding to the backscatter waveform for one of the pulses, then an inverse Fourier transform can be applied to each separate spectrum to provide analytic functions for each of the frequencies selected. More generally, many of the known phase estimation methods can be modified to provide estimations for each of the frequencies present.

### Further Configurations

a. Dual Modulator for Pulse Picking

In some cases it is desirable not to use every pulse provided by the comb generator or ring 306. For example, the ring 306 may have been designed with a small frequency shift in order to allow closely spaced frequencies, which is appropriate if the pulses are of relatively long time duration. However, if the equipment is then used with shorter pulses, their spectra could overlap and thus make the separation of the contribution of each individual frequency difficult.

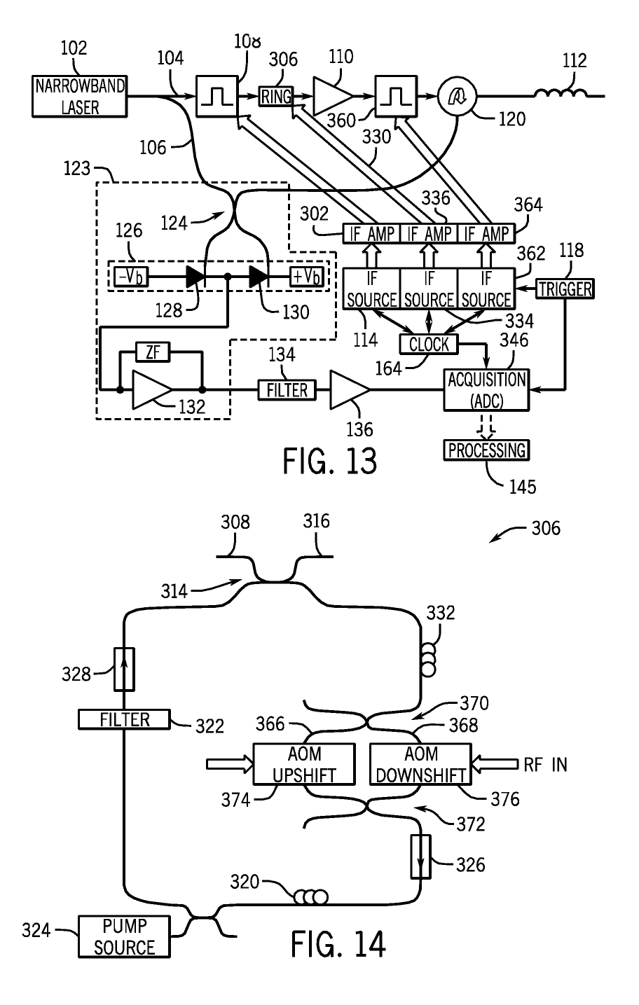

FIG. 13 illustrates an arrangement that allows only certain pulses to be extracted from the train generated by the comb generator or ring 306. An additional modulator 360 is inserted in the path between the optical pulse amplifier 110 and the output circulator 120. This modulator 360 might also be of the AOM-type and conveniently it can be used to compensate, or partially compensate, the frequency shift of AOM 108. If the modulator 360 is of the acousto-optic type, then an additional IF source 362 and an IF amplifier 364, triggered by the clock 164 also are employed, as shown in FIG. 13. However, any modulator that is fast enough to turn on and off between pulses of the comb generator or ring 306 would be suitable. For example most electro-optic modulators, if suitably driven, could be employed.

In other embodiments, the optical amplifier 110 can be moved to a position after the modulator 360, or a separate stage of amplification can be provided at this point.

b. Up/Down Rings

In some cases, it is desirable to increase the span of frequencies that are addressed and it may be acceptable to do this in separate acquisitions. It may also be desirable to have some flexibility as to the frequency spacing in the resulting comb.

In this latter case, the arrangement of the ring circuit 306 may be modified to provide separate paths, with a first path containing an upshift modulator and the second path containing a downshift modulator. Acousto-optic modulators with optical fiber inputs and outputs can be readily purchased with a specified direction of the frequency shift—which the manufacturer aligns accordingly.

In FIG. 14, one embodiment of the ring 306 is shown where the path through the frequency shifting device has been split into a first path 366 and a second path 368 and then recombined by means of a pair of directional couplers 370, 372, which typically would split the optical power equally between their output ports. In paths 366 and 368, AOMs 374 and 376 are respectively positioned. The RF inputs to the AOMs 374 and 376 are programmed so as to turn on the AOM 374 or 376 of interest for each pulse.

For example if we wish to generate first a comb with increasing frequencies and on the second acquisition a comb with decreasing frequencies, then during the first acquisition, an RF input is applied only to AOM 374. And, if on the subsequent acquisition a purely decreasing comb is required, then AOM 376 would be activated during that acquisition. Assuming the shift between frequencies required is approximately that provided by the AOMs 374 and 376, then all the output pulses can be passed by the modulator 360 (if present).

The frequency separation can be varied slightly by driving the AOMs 374 and 376 in the ring 306 at a frequency different from their design value. Typically, AOMs will allow the RF drive to differ from the nominal frequency by about 15% for an additional loss of 3 dB (relative to the design at band center). Thus an AOM designed for operation at 110 MHz, would provide shifts between 95 and 125 MHz, with a penalty as to transmission of about 50% at the extremes of this range. However, if smaller frequency shifts are required, then AOM 374 and AOM 376 can be used alternately. For example, for small frequency shifts one could operate AOM 374 at 125 MHz and on alternate passes around the ring 306, AOM 376 at 95 MHz. This arrangement would provide a net shift of +30 MHz for alternate pulses. By gating out every second pulse with the modulator 360, a sequence of closely spaced frequencies can be achieved. Obviously, negative shifts (−30 MHz for instance) can be achieved by driving AOM 376 at 125 MHz and AOM 374 at 95 MHz for alternate pulses. For somewhat higher frequency shifts, but still less than that allowed by a single AOM, a two-up, one down sequence can be selected.

For instance, AOM 374 could be driven at 95 MHz for two successive pulses and then AOM 376 could be driven at 125 MHz for a single pulse, with the modulator 360 selecting every third pulse. This arrangement would yield a pulse train spaced by three transit times around the ring 306 and shifted by 65 MHz between pulses. Where frequency shifts larger than a single pass through an AOM are required, then the two-up, one down approach can be used with for example, a double pass with a shift in one direction of 125 MHz, followed by one in the opposite direction of 95 MHz, which would result in a net frequency shift, for every third pulse, of 155 MHz.

Clearly more complex patterns still can be devised to provide a wide variety of frequency combs. In addition, the two AOMs 374 and 376 could be selected to operate at different nominal frequencies, such as 110 MHz and 165 MHz. In addition, one or more further AOMs can be added in further parallel paths, for example in order to be able to select a wider range of frequency shifts.

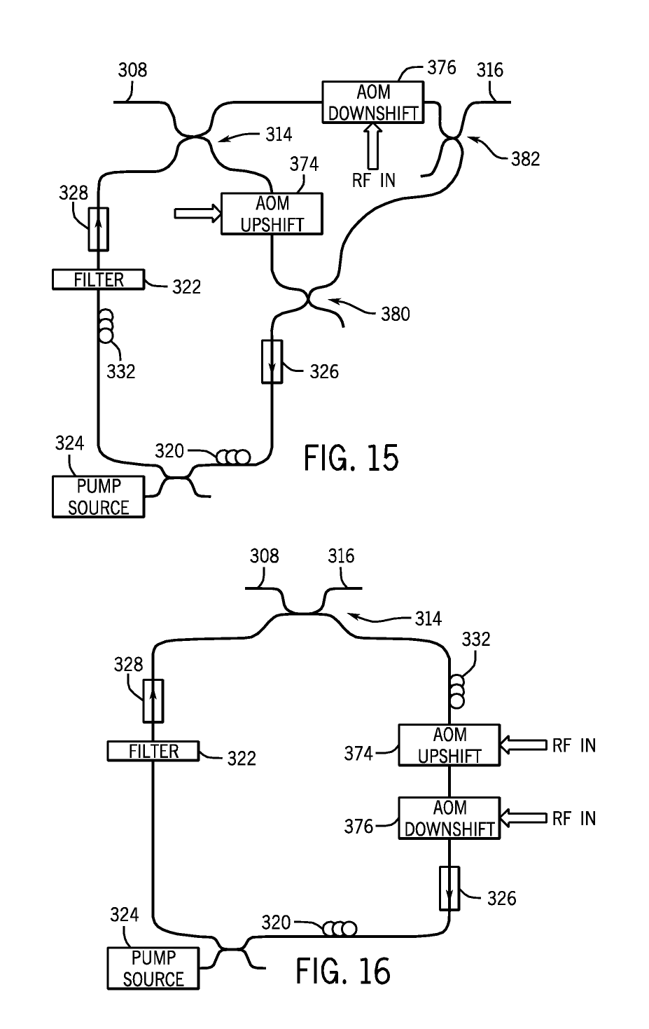

A slightly less flexible arrangement, but one that economizes on one AOM (an expensive component, particularly when the requirement to drive it is considered) is shown in FIG. 15. In this embodiment, the circulating path is separated in such a way that only pulses passing through AOM 376 can be exited from the ring 306. In a limited way, the second AOM 376 fulfills the function of the modulator 360 in FIG. 13 if the comb generator 306 is used in a slightly restricted manner. In this implementation, a pulse entering the ring can be shifted through either AOM 376 or AOM 374. In the latter, no exit pulse is possible. Only when AOM 376 is activated will a pulse be exited from the ring. This arrangement can be useful in implementations in which a train of pulses with a small frequency shift is desired. That is, the arrangement can provide for a pulse train where each pulse that has been emitted from the ring has been shifted up in one pass around the ring and then down again—by a different amount—relative to the previous pulse emitted from the ring.

A variation of the arrangement of FIG. 15 is shown in FIG. 22. Here, one or the other of the AOMs 374, 376 provides the output pulse as well as the frequency shift.

Returning to FIG. 14, the pair of couplers 370 and 372 add to the loop loss (a total of at least 6 dB). If it is known that a pass through each AOM 374 and 376 will always be required for the pulses allowed through to the output 316 of the comb generator 306, then the more efficient arrangement of FIG. 16 may be used. Thus, whereas in FIG. 14 the AOMs 374 and 376 are arranged in parallel paths, in FIG. 16 they are in series. This arrangement eliminates the couplers 370 and 372 and also reduces the number of passes around the loop of the ring 306. The arrangement of FIG. 16 would be particularly suitable in applications which benefit from a large number of frequencies, closely spaced. FIG. 16 will be particularly useful for generating frequency shifts smaller than the smallest available central frequency for an AOM (c. 40 MHz). In contrast, the arrangement of FIG. 14 is more flexible, in that both large and small frequency shifts can be produced by a single apparatus.

c. Amplification

In the embodiments described thus far, only one amplifier has been shown outside the ring circuit 306. In other embodiments, it may be beneficial to provide gain in several distinct places, such as before and after the final modulator 360 in FIG. 13, or between the first modulator 108 and the ring 306. There is a limit to the peak power that can be launched into the sensing fiber 112 due to non-linear effects. This limit will depend on a number of factors, such as the pulse duration and the fiber length, and in general, it is desired to amplify the probe pulses up to that limit.

For a number of reasons, it can be desirable to split the gain in the upper path 104 through the system into several stages. One reason is that the amplification process adds noise and thus keeping the signal at a reasonable level throughout avoids the probe pulses becoming too badly corrupted by noise. Secondly, depending on the output power of the narrowband optical source 102, the losses through the modulators 108, 374, 376, 360 and the desired output power, a significant amount of optical gain (>35 dB) could be required and a single stage amplifier with this gain can be noisy. In addition, the final AOM 360 is likely to be lossy (at least 3 dB), but it does have the benefit of eliminating amplified spontaneous emission (ASE) noise that could have built up between pulses. Thus, in some embodiments, some gain can be provided before the final modulator 360 (the ASE from which can be time-gated by the final modulator 360), which provides a final power boost immediately prior to launching into the sensing fiber 112.

In deciding the exact balance of amplification through the systems, issues such as the total pump power required, the number of pump diodes, the buildup of noise through the system, non-linear effects within the system and many others are considerations.

d. Variable Resolution.

In some implementations, it may be desirable to measure the sensing fiber 112 at more than one spatial resolution simultaneously. A small spatial resolution requires, inter alia, a short probe pulse. The arrangements described above have the potential to operate the apparatus in a multi-resolution mode. One means of achieving multi-resolution operation is to arrange for the pulses defined by AOM 180 to be at least as broad as required for the coarsest resolution desired, for example 100 ns, corresponding to a resolution cell of approximately 10 m (the length of fiber occupied by the pulse at any one time). All the pulses emerging from the ring 306 will then be of the same duration. However, in implementations where it is also desired that some of the frequencies be related to shorter duration pulses, then modulator 360 can be driven in such a way as to only be open for part of the duration of some of the pulses. In this way, one set of pulses can be of one duration, 100 ns for example, and another of, say, 20 ns. Using the techniques described above for controlling the frequency shift between pulses, the RF inputs to all the AOMs in the system (e.g., AOMs 108, 374, 376, 360) can be defined so as to create, for example a first train of pulses of duration 100 ns and separated by say 20 MHz and a second set of 20 ns pulses separated by 100 MHz. Both sets of pulses would be part of the same pulse train output by the ring 306 and acquired in a single acquisition cycle.

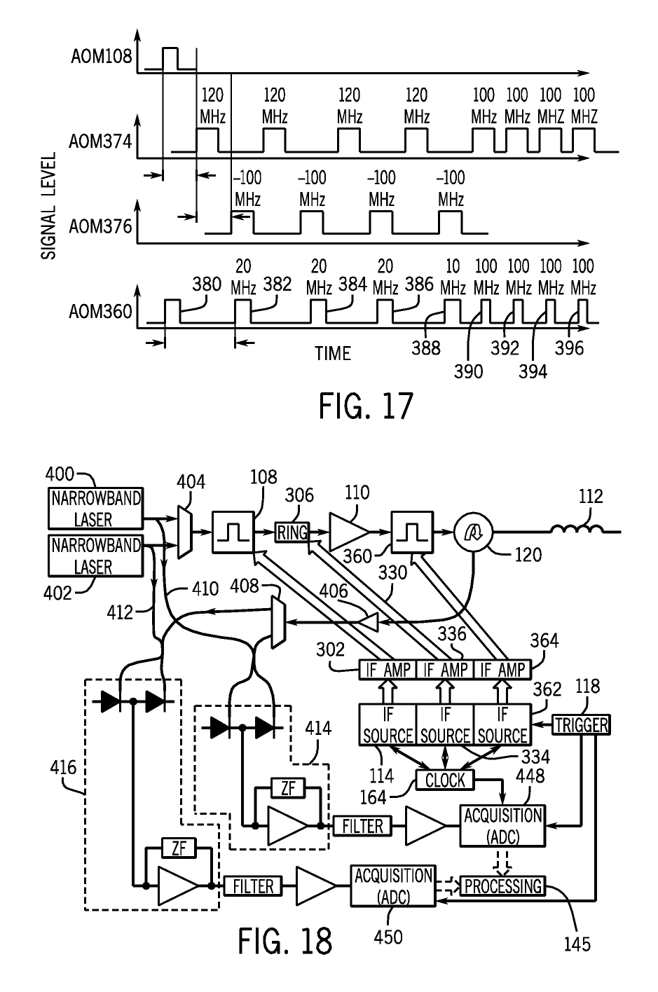

Some of the concepts described above are illustrated in FIG. 17 which assumes that the system includes a ring comb generator 306 of the type shown in FIG. 14 and the additional IF source 362 shown in FIG. 13. FIG. 17 illustrates transmission of each AOM 108, 374, 376, 360 as a function of time for an example pulse set, where the incremental frequency shift is shown above each pulse.

The versatility of this combination of arrangements can be seen in the generation of a train of five broad pulses 380, 382, 384, 386, 388 separated in frequency by 20 MHz followed by a further four pulses 390, 392, 394, 396 separated by 100 MHz (e.g., the lower pulse train for AOM 360 in FIG. 17). A wide variety of pulse durations and frequencies can be generated under electronic control (or, alternatively, software control) with this arrangement. Furthermore, if desired, a completely different pattern of pulse durations and frequencies could be generated in the very next acquisition cycle. In some implementations, the system can be controlled by synthesizing the RF signals from a 4-channel arbitrary waveform generator, which includes a set of digital-to-analog converters (DAC) fed from a pre-programmed memory containing digital representations of the RF waveforms, and their respective timings, to be applied to each AOM 108, 374, 376, 360. At the start of the acquisition cycle, all four memories are clocked out to the DACs, which thus output an approximation of the various bursts of RF required to open each AOM 108, 374, 376, 360, with the correct frequency shift at the correct time. Moreover, this arrangement allows the pulses to be apodised in order to minimize the spectral leakage from one frequency band to the others.

Since some of the non-linear limitations on probe power are pulse-energy dependent, rather than pulse-power dependent, it may be necessary to reduce the power of some pulses relative to others. This may easily be achieved by reducing the RF drive to AOM 360 for the pulse that has to be reduced in peak power.

### Multiple Laser Configurations

In certain cases, it may be desirable for the pulses to occupy a wide spectrum, even though wide gaps in the spectrum might be allowable. An interferometric array system, discussed below, is one such example, where it is desirable to provide a sparse sampling of the frequency space, but dense in certain parts of the spectrum.

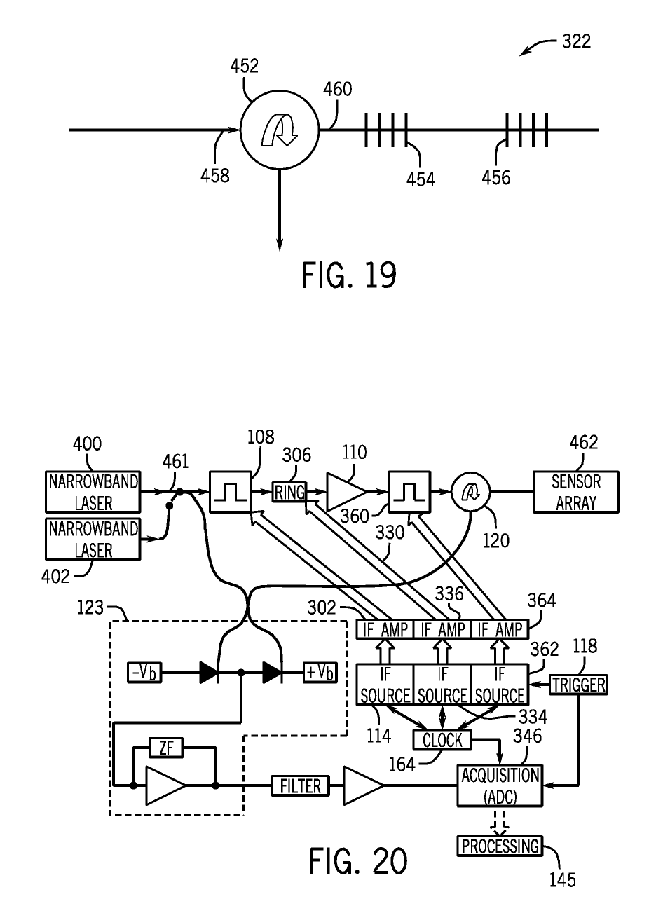

FIG. 18 shows an embodiment which achieves this objective. In this embodiment, two sources 400, 402 are shown for clarity, but it should be understood that the arrangement can be extended to many more optical sources if desired. The sources 400, 402 each provide a local oscillator, but are multiplexed by multiplexer 404 prior to the remainder of their outputs passing through the pulse modulator 108, comb generator ring 306 and output amplifier 110 and output modulator 360 (if present). The backscatter returning from the sensing fiber 112 can be pre-amplified optically by an amplifier 406 and possibly filtered prior to being demultiplexed by a demultiplexer 408, as shown in FIG. 18. The backscatter associated with each source 400, 402 is then mixed with the local oscillator 410, 412 tapped from the respective source 400, 402 and each mixed signal is detected and digitized separately by respective detectors 414, 416 and acquisition systems 448, 450. While this arrangement results in duplication of components (e.g., lasers, acquisition, etc.), in some applications the backscatter created by each source 400, 402 should be acquired simultaneously and the arrangement of FIG. 18 achieves this objective.

Where the sources are widely separated, the filter 322 used in the ring 306 is preferably a multiple narrowband device, such as is provided by the combination of a circulator 452 and a series of fiber Bragg gratings 454, 456, as illustrated in FIG. 19.

In this filter device 322, light enters the input 458 of the circulator 452, passes to the common port 460 and is selectively reflected by the gratings 454, 456 that are inscribed in series in this fiber. The wavelength, breadth and reflectivity of the gratings 454, 456 can be tailored precisely to match the frequencies that the ring 306 is to deliver, with usually some contingency for tolerances between the specified grating reflectivity spectrum and the emission wavelength of the lasers 400, 402. Gratings offering reflections bands well below 10 GHz are available. The relative strength of the reflectivity between the multiple gratings 454, 456 in the filter 322 can be used to equalize the gain of the optical amplifier 320 in the ring 306 which is frequently wavelength-dependent.

In a variant to this embodiment, the multiple sources 400, 402 can be derived from a single master source. In this case the output of the master source is converted to a comb using a recirculating ring, and selected lines of the comb can be used to injection-lock a semiconductor laser to those lines.

### Further Frequency Shifting Techniques

The arrangements for generating multiple pulses shifted in frequency with respect to each other have so far involved some form of re-circulating optical circuit including at least one frequency shifter. However it should be understood that other arrangements of a multiple-frequency coherent-detection OTDR system can generate multiple, frequency-shifted pulses without the use of a re-circulating optical circuit.

For example, in the OTDR system shown in FIG. 23, the output of the narrowband optical source 102 is modulated by a modulator 500. Here, the modulator 500 can be any one of various types of modulators that are configured to add at least one sideband to the optical spectrum of the output of the optical source 102 that can be selected by a filter 502. In FIG. 23, the filter 502 corresponds to the combination of a circulator 504 and a grating 506. For example, if the modulator 500 is an intensity or a phase modulator, the application of a sinusoidal drive voltage to the input of the modulator 500 will result in upper and lower sidebands in the spectrum of the output of the optical source 102. The number of sidebands generated will depend on the modulation parameters. Other implementations may employ a type of modulator 500, such as the MXIQ-LN-40 supplied by Photline Technologies (France), that is designed specifically to convert most of the spectrum of the input to a single spectral line in its output. In such implementations, the filter 502 after the modulator 500 can be used to remove any unwanted residual light at the original output frequency of the optical source 102.

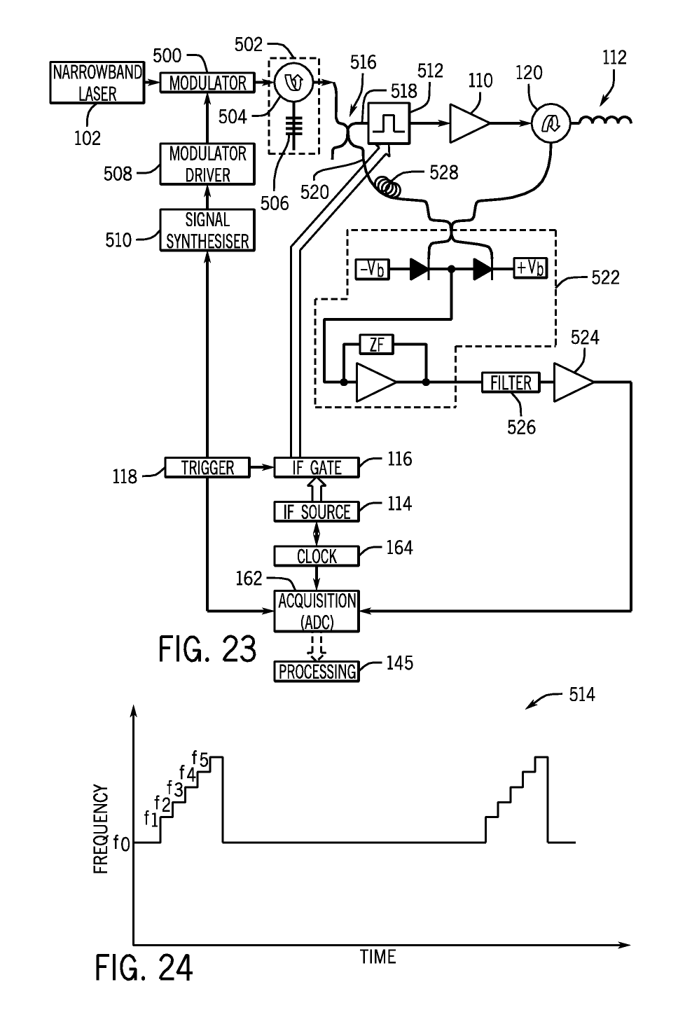

Referring still to FIG. 23, the modulator 502 is driven by a modulator driver 508 that receives a synthesized drive signal from a signal synthesizer 510 to generate a composite-frequency pulse. The synthesized drive signal is synchronized via the trigger 118 with the acquisition system 162 and a modulator 512 that selectively launches the composite-frequency pulse into the sensing fiber 112. In this arrangement, if the signal synthesizer 510 and modulator driver 508 apply a sinusoidal drive to the modulator 500, at the output of the filter 502 an optical signal at a single optical frequency is emitted. This frequency can be shifted under electronic control by the signal synthesizer 510 and modulator driver 508 over a wide range, thus creating a frequency versus time function, such as the function 514 illustrated in FIG. 24. In this case, the frequency of the signal emitted by the filter 502 is usually f₀, but on a periodic basis, the frequency moves to f₁, f₂, f₃, f₄ and f₅ and then back to f₀. The frequency pattern 514 of the composite pulse illustrated in FIG. 24 is exemplary only, and other frequency patterns may be used and the number of frequency steps, their frequency separation and the order in which the frequencies appear in the sequence can all be adjusted by electronic control.

Returning now to FIG. 23, the output of the filter 502 is split by a coupler 516 into a probe path (upper) 518 and an LO path (lower) 520. In the probe path 518, the second modulator 512 is driven by the IF gate 116 so that the modulator 512 selects the output of the filter 502 for times when the frequency of the signal departs from f₀. This arrangement thus creates a multi-frequency composite pulse at the output of the modulator 512 that is shifted by varying amounts from f₀. This composite pulse can be amplified by an optical amplifier 110 and launched into the sensing fiber 112 via the circulator 120. The backscatter returning from the sensing fiber 112 in response to the composite pulse is combined with the spectral line from the LO path 520 and presented to a receiver 522, such as a balanced receiver (as illustrated). The signal from the receiver 522 is conditioned (e.g. amplified by amplifier 524 and filtered by filter 526) prior to being digitized by the ADC acquisition system 162.

In the arrangement shown, the LO path 520 includes an optical fiber delay line 528 that is intended to approximately match the duration of the pulse train launched into the fiber 112 so that the backscatter from the sensing fiber 112 coincides with light in the LO path 520 largely at f₀. A similar result can be achieved by adding a section of fiber in series with, and prior to, the sensing fiber 112 and ignoring the backscatter from this added fiber section. By way of example, f₀ might be selected to be 14 GHz and f₁, f₂, f₃, f₄ and f₅ to be 14.15, 14.25, 14.35, 14.45 and 14.55 GHz, respectively. When the Rayleigh backscatter is mixed with the (suitably delayed) LO on the receiver 522, detected signals will thus contain components at 150, 250, 350, 450 and 550 MHz which can readily be digitized by the acquisition system 162 (e.g. an A/D converter sampling at 1.2 Gsamples/s or higher) and processed as previously described. Modulator 512 can be programmed to pass the entire composite pulse or to open and close repeatedly to exclude the frequency transitions in the composite pulse. Many other combinations of frequencies, pulse durations, etc. can be used in the arrangement of FIG. 23.

As described, the arrangement of FIG. 23 mixes a shifted light (LO) at f₀ with the backscatter from differently shifted light pulses (at f₁ to f₅ in the example). It would be possible to use as an LO in the LO path 520 light taken directly at the unmodulated laser 102 frequency f_{c}. In this case, the mixing of the backscatter received from the fiber 112 with the light in the LO path 520 at the receiver 522 would result in frequency components at around f₁ to f₅ in the example. The resulting outputs can then be digitized by the acquisition system 162 using a sub-sampling technique. In such a case the sampling rate does not meet the Nyquist criterion but approximate knowledge of the frequencies to be detected allows the undersampled waveforms still to be reconstructed and the phases extracted.

The signal(s) controlling the modulator 500 can be synthesized for example by direct synthesis of f₁ to f₅ using specialized integrated circuits such as the AD 9914 from Analog Devices Inc., which can synthesize frequencies up to 1.75 GHz and then to mix the synthesized output with a signal at f₀ in a mixer. In other implementations, f₁ to f₅ can be synthesized by reading a digital version of the desired waveform stored in a memory to a D/A converter or generated from a voltage-controlled oscillator.

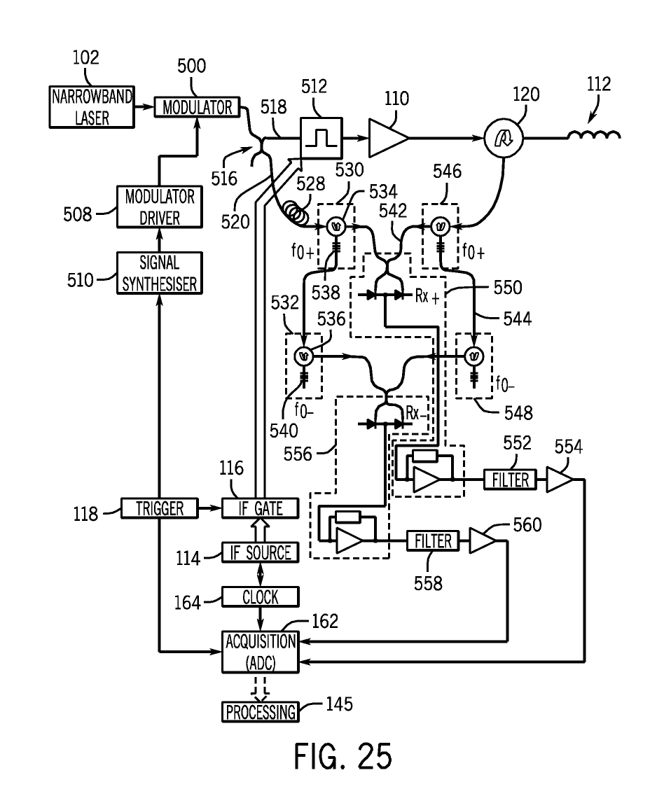

In implementations in which the modulator 500 generates several sidebands and where it is desired to use these sidebands, the arrangement of FIG. 25 can be used. In this case, the modulated spectrum is transmitted unfiltered to both the LO path 520 and the probe path 518. The pulse in the probe path 518 can be further gated by the modulator 512 and amplified by amplifier 110 (as in FIG. 23). The probe pulse (which now contains several composite pulses each located on a different sideband of carrier frequency f_{c}) is launched into the sensing fiber 112 and the resultant backscatter signal separated from the forward travelling light by the circulator 120. In the LO path 520, the delay line 528 is encountered and the LO signal is then split into the two sidebands—labeled f₀₊ and f₀₋—by means of filters 530 and 532. As shown in FIG. 25, the filters 530 and 532 are represented by circulators 534, 536 and fiber Bragg gratings 538, 540. The labeling f₀₊ and f₀₋ refers to the approximate location of the peak reflection frequency of the Bragg gratings 538, 540.

The backscatter corresponding to each sideband (as split by filters 546 and 548) is mixed with the corresponding LO signal and the mixing result is detected, conditioned and acquired in separate channels 542 and 544. As shown, the channel 542 includes the receiver 550, filter 552 and amplifier 554. The channel 544 includes the receiver 556, filter 558 and amplifier 560. The f₀₋ and f₀₊ are intended to represent the first upper and lower sidebands which would be produced for example if the modulator 500 were a phase modulator driven at a frequency around f₀. However, other sidebands such as 2f₀ and higher multiples can appear in the output spectrum if the modulation index is selected appropriately. In any event, the technique described herein allows multiple sets of pulses of selectively chosen duration and frequency to be launched into the fiber 112, each set being separated by a wider frequency interval. This type of arrangement is well-suited for frequency plans that might be used in static arrays with point reflectors (see discussion below) and may also have benefits in coherent-detection OTDR systems that based on Rayleigh backscatter.

In yet other embodiments, further sources (with wider frequency separation than can be achieved with the techniques described in connection with FIG. 25) can be multiplexed through the same optics and separated for individual detection similarly to the arrangements of FIG. 20 or 18, but also benefiting from the generation of sidebands via a modulator 500, rather than a re-circulating ring,

### Applications

a. Heterodyne DVS.

One issue in coherent-detection OTDR is the fading phenomenon, namely that at certain locations in the sensing fiber, the summation of electric fields from all the scatterers sums to approximately zero. At these locations, no signal can be obtained and therefore the signal-to-noise ratio of the phase detection is poor or even vanishing. However, the location of the fading is frequency-dependent and is a function of the precise location of the scatterers in a particular piece of fiber. It follows that if the sensing fiber is interrogated at a different frequency, the fading may well be replaced by a strong signal. These effects are statistical, but with a sufficient number of frequencies, the likelihood of a fade at any particular location is reduced to an acceptable level. Typically, three frequencies are sufficient to ensure a very low probability of a fade.

By “frequency” in this context, we mean a frequency that is sufficiently separated from neighboring frequencies as to be statistically independent, and this is known to be at least the inverse of the pulse duration. In practice, the minimum separation between frequencies may be dictated by the ability to distinguish them in the filtering; and a practical limit is believed to be at least twice the reciprocal of the probe pulse duration. Therefore, if frequencies are sufficiently different to be separated in the signal processing, they will also be statistically independent.

Once the probability of fading is sufficiently low, then further frequencies continue to improve the signal-to-noise ratio by providing further independent measurements of the same vibration signal. The signal-to-noise ratio is thus expected to improve in proportion to the square root of the number of pulses used.

There is scope for optimizing the way in which the multiple backscatter signals are aggregated. One method is to calculate a weighted mean, based on the signal strength. This is available in the windowed Fourier transform and can be used to weigh the averaging. However in certain circumstances a robust estimate may be used, for example where outliers are detected and eliminated, or even by selecting the median rather than the arithmetic average of the signals available for each location.

In some circumstances, it is desirable to acquire the vibration signal with different spatial resolutions. With a multi-frequency arrangement as described above, it is possible to select one pulse duration for some frequencies and a different pulse duration for at least another set of frequencies. In this way, it is possible simultaneously to acquire the same information at multiple resolutions.

Interferometric sensor arrays are frequently used to multiplex a large number of sensors together. In many cases, they are multiplexed in the time domain. In other words, they are distinguished one from another according to the time-of-flight of the interrogating signal from the source to the sensors and back to the receivers in the interrogator. This is very similar to the case of coherent OTDR vibration sensing discussed at length above, the main difference being that the multiplexed sensors are generally discrete entities, typically containing a significant length of fiber wound in such a way as to enhance the sensitivity to one measurand and minimize cross-sensitivity to an unwanted parameter.

The source arrangement and interrogation techniques disclosed herein and described in their application to distributed sensors based on backscatter can also be applied to discrete sensor arrays. In some cases, the sensors return backscattered light in a certain way. In this case, the benefits disclosed above for a distributed sensor apply directly across to the sensor array, because the physical origin of the signal detected is the same as in fully distributed sensors, namely Rayleigh backscatter.

In other cases, however, the sensors have a discrete, localized response. This is the case, for example, if the sensor array consists of a series of discrete sensors, separated by weak reflectors. This technique may be used to multiplex large numbers of sensors in the time domain and has been extended to hybrid time-domain/wavelength domain multiplexing. The reflector could be a splice containing a medium deliberately mismatched in refractive index from that of the glass, or a fiber Bragg grating or indeed formed by a tap-coupler and a mirror. The key distinction between systems where the signal originates in scattering from those that use discrete reflectors is that, in the latter case, the phase of the reflection is predictable and usually wavelength independent, other than a phase term directly related to distance from the source. In contrast, in the case of backscattered signals, the phase of the scattered signal from a particular location is random and varies with probe pulse frequency.

Thus, in the case of a system including definite, localized reflectors, the invariance of the reflected phase with wavelength can be exploited. One method of achieving this can be to interrogate such arrays with a range of wavelengths (using a dual-pulse technique), acquire the phase for each pulse-pair (a measure of the distance between adjacent reflectors) and unwrap the phases thus acquired over a sufficient wavelength range to be able to determine the absolute distance between reflectors. It should be understood that the phase measurement is a non-unique measurement, in that for any measured value of the phase, there is a vast range of fiber lengths between reflectors that would give the same phase reading. (In fact, unless constrained by some a priori rough knowledge of the distance between reflectors, the number of fiber lengths which match a measured phase is infinite). However, by including successively more phase measurements, made at different probe wavelengths, the solution to the determination of the length between reflectors is gradually more constrained until a definite value of this length is arrived at. Given an absolute measurement of the distance between reflectors—i.e. with the fringe order determined—a number of very precise measurements, for example of temperature, strain or pressure, can be accomplished. These arrays are sometimes known as “static arrays” since they are able to measure quasi-static quantities, such as temperature, in contrast to dynamic arrays, that rely on fringe tracking, which are capable of measuring only changes in a particular property, such as acoustic signals, because the continuity of the measurement would be lost for example if the power supply were interrupted.

Unfortunately, implementing this technique has proven rather unwieldy and to our knowledge this absolute measurement has not been accomplished in practice. However, the techniques disclosed herein simplify the implementation of the static array concept considerably. One of the reasons is that the heterodyne approach allows only one pulse per wavelength to be used, which simplifies the frequency plan for the interrogation substantially. Secondly, the comb frequency approach in combination with the simultaneous acquisition of the response to multiple probe pulses (each at different frequencies) speeds up the acquisition so that the measurement can be consistent across all frequencies. The embodiment shown in FIG. 18 is particularly well suited for such implementations. Where the conditions are a little more stable (e.g. temperature and pressure varying only slowly) then the arrangement of FIG. 20 can be implemented, where a single set of acquisition electronics is used and several lasers (two shown for clarity) are switched in via a switch device 461.

The approximate boundary between where FIG. 20 may be used and a fully parallel arrangement such as FIG. 18 is better suited, may be determined by considering the expected rate of change of the physical parameter. For example, assume a sensor array 462 (or sensing fiber 112) is intended to measure temperature and each sensing element is about 10 m long. If the resolution of phase for a group of frequencies addressed by a single optical source is 1 mradian, this corresponds to about 4 μK. Thus, if the pulse repetition frequency is 10 kHz and a different optical source is switched in between pulses, and a total of three sources are used, then the entire measurement must be stable to within 4 μK over a time of 0.33 ms. It follows that the maximum rate of change of temperature to avoid problems in phase unwrapping would be of order 12 mK/s, i.e. 0.7 K/min. There are a number of cases where this result is acceptable (and the arrangement of FIG. 20 then may be used). If conditions are changing faster than this, then an arrangement such as FIG. 18 would be better suited.

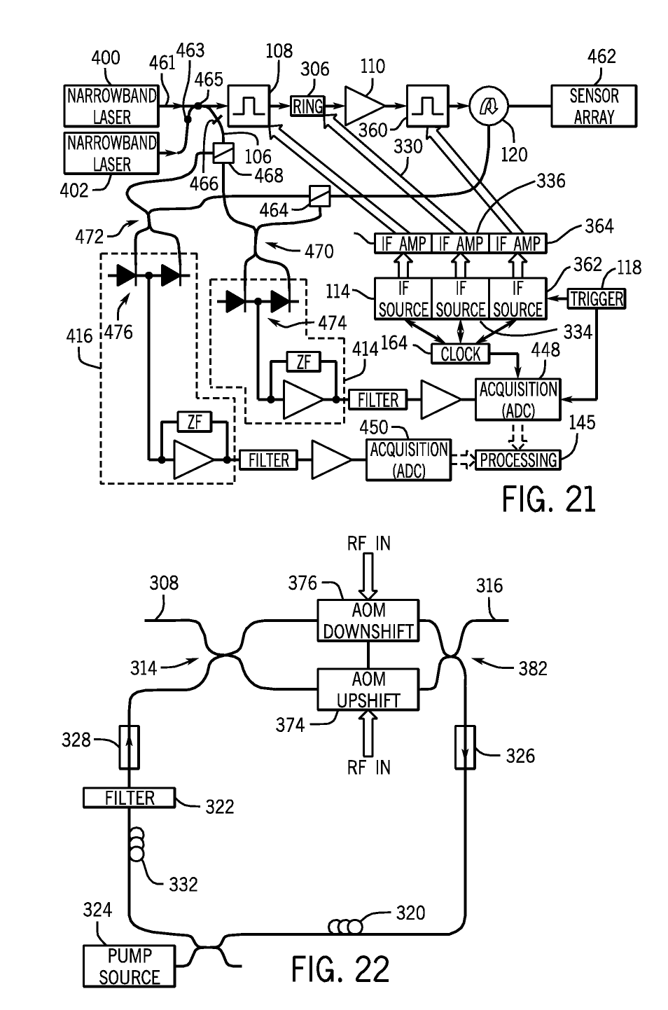

In many cases it is desirable to measure two orthogonal polarizations simultaneously. This means that the local oscillator and the returned backscatter signals must each be split into orthogonal components and acquired separately. This can be done using either the embodiments of FIG. 18 or FIG. 20, or indeed other variations previously discussed. We will illustrate the changes required for dual polarization acquisition, based on FIG. 18, and a dual polarization schematic is shown in FIG. 21.

The dual polarization arrangement of FIG. 21 is an extension of FIG. 20, with the same switching of multiple laser sources 400, 402. The difference between FIG. 20 and FIG. 21 is that in FIG. 21, both paths to the detectors 414, 416 have been split into two orthogonal polarizations. That is, the backscattered/backreflected light returning from the sensor array 462 is split with a polarizing beamsplitter (or polarization-splitting coupler) 464. In the local oscillator path 106, we want stable states of polarization to mix with the returning light, so in the arrangement of FIG. 21, the fiber leads from the lasers 400, 402, including the switch 461 and tap couplers 463, 465 is made from polarization-maintaining fiber (e.g. PANDA (supplied by Fujikura, Japan for example) or Hi-Bi fiber (supplied by Fibercore Ltd, UK)). At the splice (marked by a cross 466 in FIG. 21, the fiber from the tap coupler 465 and the fiber leading to a polarization splitting coupler 468), the principal axes of the fibers are rotated with respect to each other by 45° to ensure that roughly equal power is launched into each local oscillator lead. Both polarization-splitting couplers 464, 468 and the couplers 470, 472 used for mixing the light prior to the balanced detectors 474, 476 are preferably of the polarization-preserving type. The optics (including the polarization splitters 464, 468 and mixing couplers 470, 472) could also be manufactured in micro-bulk optics.

In some embodiments, the configuration of FIG. 21 could be modified to acquire all frequencies simultaneously (as shown for a single polarization in FIG. 18) by further multiplying the acquisition electronics.

Embodiments of the multi-frequency phase coherent-detection OTDR systems discussed above can also be employed in application other than hydrocarbon production and seismic or geologic surveying and monitoring. For instance, embodiments of the multi-frequency phase coherent-detection OTDR system can be implemented in intrusion detection applications or other types of applications where it may be desirable to detect disturbances to a fiber optic cable. As another example, embodiments of the systems described herein can be employed in applications where the fiber optic sensor is deployed proximate an elongate structure, such as a pipeline, to monitor and/or detect disturbances to or leakages from the structure.

While the inventions has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. An apparatus, comprising:
a narrowband optical source to generate a first optical signal having a first optical frequency;
a frequency-shifting circuit to generate a probe signal from the first optical signal to launch into a fiber optic sensor, the probe signal having a plurality of optical frequencies shifted from the first optical frequency;
a coherent detection system to mix backscatter signals generated by the fiber optic sensor in response to the probe signal with a local oscillator optical signal provided by the narrowband optical source to generate mixed output signals; and
a phase detection and acquisition system to filter the mixed output signals into frequency bands corresponding to the shifted frequencies, and to extract at least the phase of the mixed output signal for at least one of the frequency bands.

2. The apparatus as recited in claim 1, wherein the probe signal is a composite pulse composed of multiple optical frequencies, each optical frequency of the composite pulse being shifted from the first optical frequency.

3. The apparatus as recited in claim 2, wherein the local oscillator signal has an optical frequency shifted from the first optical frequency by a different amount than the multiple optical frequencies of the probe signal.

4. The apparatus as recited in claim 3, wherein the frequency-shifting circuit shifts the first optical frequency to generate the local oscillator signal.

5. The apparatus as recited in claim 4, wherein the frequency-shifting circuit generates a plurality of frequency sidebands to provide a corresponding plurality of probe signals and local oscillator signals, and wherein each local oscillator signal and backscatter signal generated in response to the probe signal derived from the same frequency sideband are mixed on a separate coherent detection system.

6. The apparatus as recited in claim 1, further comprising a first modulator to generate a first optical pulse from the first optical signal, and wherein the frequency-shifting circuit repeatedly shifts the first optical frequency of the first optical pulse to generate the probe signal, wherein the probe signal comprises a plurality of interrogating pulses having shifted frequencies.

7. The apparatus as recited in claim 6, where the local oscillator signal has an optical frequency that is not shifted from the first optical frequency.

8. The apparatus as recited in claim 6, further comprising a second modulator to select from the plurality of interrogating pulses selected interrogating pulses to launch into the fiber optic sensor.

9. The apparatus as recited in claim 6, further comprising a second narrowband optical source to generate a second optical signal, wherein the first modulator to generate a second optical pulse from the second optical signal, the optical pulse having a second frequency, and wherein the frequency-shifting circuit to repeatedly shift the second frequency of the second optical pulse to generate the plurality of interrogating pulses to launch into the fiber optic sensor, the plurality of interrogating pulses having a plurality of frequencies shifted from the first frequency and a plurality frequencies shifted from the second frequency.

10. The apparatus are recited in claim 6, wherein the frequency-shifting circuit repeatedly shifts the first frequency to generate a plurality of pulses of increasing frequencies.

11. The apparatus as recited in claim 6, wherein the frequency-shifting circuit repeatedly shifts the first frequency to generate a plurality of pulses of decreasing frequencies.

12. The apparatus as recited in claim 6, wherein the frequency-shifting circuit repeatedly shifts the first frequency to generate a plurality of pulses of increasing and decreasing frequencies.

13. The apparatus as recited in claim 1, wherein the coherent detection system is a heterodyne detection system.

14. The apparatus as recited in claim 1, wherein the backscatter light is Rayleigh backscatter light generated in response to the interrogating pulses.

15. The apparatus as recited in claim 1, wherein the backscatter light comprises reflected light from a plurality of discrete sensors.

16. A method of detecting a parameter of interest using a fiber optic sensor, comprising:
frequency-shifting a frequency of an optical signal from an optical source to generate a probe signal of shifted frequencies;
launching the probe signal into a fiber optic sensor;
mixing returned optical signals generated by the fiber optic sensor in response to the interrogating pulses with a local oscillator signal from the optical source to generate mixed output signals;
filtering the mixed output signals into frequency bands, each frequency band corresponding to the shifted frequencies;
extracting phase of the mixed output signal from at least one of the frequency bands; and
determining the parameter of interest based on the extracted phase.

17. The method as recited in claim 16, wherein the probe signal is a composite pulse composed of the multiple shifted frequencies.

18. The method as recited in claim 17, further comprising frequency shifting the frequency of the optical signal by a different amount than the multiple shifted frequencies to generate a local oscillator signal having a shifted frequency.

19. The method as recited in claim 16, wherein the probe signal is a plurality of pulses, each pulse having one of the shifted frequencies.

20. The method as recited in claim 19, wherein the local oscillator signal has a frequency that is not shifted from the frequency of the optical signal from the optical source.

21. The method as recited in claim 19, further comprising launching only selected interrogating pulses from the plurality of pulses into the fiber optic sensor.

22. The method as recited in claim 19, wherein frequency-shifting the frequency comprises repeatedly increasing the frequency to generate a plurality of interrogating pulses of increasing frequencies.

23. The method as recited in claim 19, wherein frequency-shifting the frequency comprises selectively increasing and decreasing the frequency to generate a plurality of interrogating pulses of increasing and decreasing frequencies.

24. The method as recited in claim 16, wherein the parameter of interest is at least one of strain and temperature.

25. The method as recited in claim 16, further comprising deploying the fiber optic sensor in a wellbore.

26. A system to detect a parameter of interest in a wellbore, comprising:
a fiber optic sensor system deployed in a wellbore;
a narrowband optical source to generate a first optical signal having a first optical frequency;
a frequency-shifting circuit to generate a probe signal from the first optical signal to launch into the fiber optic sensor, the probe signal having a plurality of optical frequencies shifted from the first optical frequency;
a coherent detection system to mix backscatter signals generated by the fiber optic sensor in response to the probe signal with a local oscillator signal provided by the narrowband optical source to generate mixed output signals; and
a phase detection and acquisition system to filter the mixed output signals into frequency bands corresponding to the shifted frequencies, and to extract at least the phase of the mixed output signal for at least one of the frequency bands, wherein the phase is indicative of the parameter of interest.

27. The system as recited in claim 26, wherein the probe signal is a composite pulse composed of multiple frequencies, each frequency of the composite pulse being shifted from the first optical frequency.

28. The system as recited in claim 27, wherein the local oscillator signal has an optical frequency shifted from the first optical frequency by a different amount than the multiple frequencies of the composite pulse.

29. The system as recited in claim 28, wherein the frequency-shifting circuit shifts the first optical signal to generate the local oscillator signal.

30. The apparatus as recited in claim 26, further comprising a first modulator to generate a first optical pulse from the first optical signal, and wherein the frequency-shifting circuit repeatedly shifts the first optical frequency of the first optical pulse to generate the probe signal, wherein the probe signal comprises a plurality of interrogating pulses having shifted frequencies.

31. The apparatus as recited in claim 30, wherein the local oscillator signal has an optical frequency that is not shifted from the first optical frequency.
